(19) United States
(12) Patent Application Publication
(10) Pub. No.: US 2022/0289344 A1
(43) Pub. Date: Sep. 15, 2022

(54) FLOATING ARRANGEMENT FOR SUPPORTING SOLAR PANELS

(71) Applicant: SCG Chemicals Co., Ltd, Bangkok (TH)

(72) Inventors: Kok Boon HEH, Singapore (SG); Natthawoot PHUENGNOI, Amphor Muang (TN); Varith PUNTURAUMPORN, Bangkok (TH); Natthakarn HEMPANON, Bangkok (TH)

(73) Assignee: SCG Chemicals Co., Ltd, Bangkok (TH)

(21) Appl. No.: 17/637,400

(22) PCT Filed: Jun. 16, 2020
(86) PCT No.: PCT/TH2020/000039

§ 371 Date: Feb. 22, 2022

(30) Foreign Application Priority Data
Aug. 22, 2019 (SG) 10201907781X

(51) Int. Cl. B63B 35/44; B63B 1/14; H02S 10/40

(52) U.S. Cl. CPC B63B 35/44; B63B 1/14; H02S 10/40; B63B 2035/4453

(57) ABSTRACT

A floating arrangement may include at least one support-floatation-unit for supporting a solar panel, the at least one support-floatation-unit has a main body having a flat base and at least one connection portion; and at least one connecting-floatation-unit having a flat base and at least one connection portion. The respective corner-connection-portions may be coupled together to form a connection joint connecting the support-floatation-unit and the connecting-floatation-unit in a side-by-side arrangement. A height from the base of the support-floatation-unit to the connection joint may be larger than a height from the base of the connecting-floatation-unit to the connection joint such that the base of the support-floatation-unit may extend downwards from the base of the connecting-floatation-unit by a depth which defines an additional displacement volume of the support-floatation-unit configured to provide additional buoyancy to support the solar panel.

### FIELD OF INVENTION

Various embodiments generally relate to a floating arrangement for supporting solar panels. In particulars, various embodiments relate to a floating arrangement for supporting solar panels in the open seas or ocean, as well as inland water or sheltered seas or water catchment.

### BACKGROUND

Floating solar panel systems typically include solar panels mounted on floating structures. The conventional floating structure usually includes a plurality of floating units that are joined together via a coupling assembly for securing the floating units to each other.

Such conventional floating structures for supporting solar panels have mostly been deployed in inland water or sheltered seas or water catchment where water conditions are stable (i.e. the conventional floating structures do not experience any effects from strong winds such as big waves). In attempts to utilise the vastness of the open seas for harnessing solar power, deployment of floating solar panels system has recently venture into the open seas and ocean. However, the harsh water conditions due to strong wind and/or sea wave and/or tidal forces in the open seas and ocean have observed to cause frequent damage to the conventional floating structure, typically along the coupling assembly as well as along the body of the floating units near the joints. Accordingly, conventional floating structures have found to be not suitable for deployment in the open seas and ocean for supporting solar panels.

Accordingly, there is a need for a more durable and effective floating arrangement to address the above issues.

### SUMMARY OF THE INVENTION

According to various embodiments, there is provided a floating arrangement for supporting a solar panel. The floating arrangement may include at least one support-floatation-unit for supporting a solar panel. The support-floatation-unit may include a main body having a flat base and at least one connection portion protruding sideways from a chamfered corner wall between two side walls of the main body in a direction parallel with the flat base. The floating arrangement may include at least one connecting-floatation-unit. The connecting-floatation-unit may include a main body having a flat base and at least one connection portion protruding sideways from a chamfered corner wall between two side walls of the main body in a direction parallel with the flat base. The at least one connection portion of the at least one support-floatation-unit may be coupled to the at least one connection portion of the at least one connecting-floatation-unit to form a connection joint which connects the at least one support-floatation-unit and the at least one connecting-floatation-unit in a side-by-side arrangement, whereby one of the two side walls of the main body of the at least one support-floatation-unit abuts one of the two side walls of the main body of the at least one connecting-floatation-unit. According to various embodiments, a height from the flat base of the at least one support-floatation-unit to a center of the connection joint may be larger than a height from the flat base of the at least one connecting-floatation-unit to the center of the connection joint in a manner such that the flat base of the at least one support-floatation-unit extends downwards from a base level of the flat base of the at least one connecting-floatation-unit by a depth which defines an additional displacement volume of the at least one-support-floatation-unit configured to provide additional buoyancy to support the solar panel. According to various embodiments, the main body of the at least one connecting-floatation unit may be of an elongate shape. The main body of the at least one connecting-floatation-unit may have an overhanging protrusion extending longitudinally outwards from an upper half of a first longitudinal end of the main body of the at least one connecting-floatation-unit and an underside socket extending inwards at a lower half of the first longitudinal end of the main body of the at least one connecting-floatation-unit. According to various embodiments, the main body of the at least one connecting-floatation-unit may further have an upper-side socket extending inwards at an upper half of a second longitudinal end of the main body of the at least one-connecting-floatation-unit and a foot protrusion extending longitudinally from a lower half of the second longitudinal end of the main body of the at least one-connecting-floatation-unit.

According to various embodiments, there is provided a floating solar panel system including the floating arrangement as described herein and at least one solar panel mounted to the at least one support-floatation-unit of the floating arrangement.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a side view of a floating arrangement for supporting a solar panel according to various embodiments;

FIG. 2 shows a perspective view of a floating arrangement according to various embodiments;

FIG. 3A to FIG. 3C show a perspective view, a side view and a top view of the support-floatation-unit of the floating arrangement of FIG. 1 and the floating arrangement of FIG. 2 according to various embodiments;

FIG. 4A to FIG. 4D show a perspective view, a side view, a top view and a bottom view of the connecting-floatation-unit of the floating arrangement of FIG. 1 and the floating arrangement of FIG. 2 according to various embodiments;

FIG. 4E and FIG. 4F show a perspective top view and a perspective bottom view of a first variant connecting-flotation-unit of the connecting-flotation-unit of the floating arrangement of FIG. 1 and the floating arrangement of FIG. 2 according to various embodiments;

FIG. 4G and FIG. 4H show a perspective top view and a perspective bottom view of a second variant connecting-flotation-unit of the connecting-flotation-unit of the floating arrangement of FIG. 1 and the floating arrangement of FIG. 2 according to various embodiments;

FIG. 4I and FIG. 4J show a perspective top view and a perspective bottom view of a third variant connecting-flotation-unit of the connecting-flotation-unit of the floating arrangement of FIG. 1 and the floating arrangement of FIG. 2 according to various embodiments;

FIG. 4K and FIG. 4L show a perspective top view and a perspective bottom view of a fourth variant connecting-flotation-unit of the connecting-flotation-unit of the floating arrangement of FIG. 1 and the floating arrangement of FIG. 2 according to various embodiments;

FIG. 5 shows a perspective bottom view of the support-floatation-unit of FIG. 3A according to various embodiments; and

FIG. 6A and FIG. 6B shows a perspective view and a top view of a floating arrangement according to various embodiments.

FIG. 7 shows a top view of an example arrangement of the first variant connecting-floatation-unit, second variant connecting-flotation-unit, third variant connecting-flotation-unit and fourth variant connecting-flotation-unit, according to various embodiments.

### DETAILED DESCRIPTION OF PREFERRED EMBODIMENTS

Embodiments described below in the context of the apparatus are analogously valid for the respective methods, and vice versa. Furthermore, it will be understood that the embodiments described below may be combined, for example, a part of one embodiment may be combined with a part of another embodiment.

It should be understood that the terms “on”, “over”, “top”, “bottom”, “down”, “side”, “back”, “left”, “right”, “front”, “lateral”, “side”, “up”, “down” etc., when used in the following description are used for convenience and to aid understanding of relative positions or directions, and not intended to limit the orientation of any device, or structure or any part of any device or structure. In addition, the singular terms “a”, “an”, and “the” include plural references unless context clearly indicates otherwise. Similarly, the word “or” is intended to include “and” unless the context clearly indicates otherwise.

Various embodiments have provided a floating arrangement for supporting solar panels. In particulars, various embodiments have provided a floating arrangement for supporting solar panels in the open seas or ocean, as well as inland water or sheltered seas or water catchment. According to various embodiments, open seas or ocean may include any part of the sea not enclosed between headlands or sheltered. According to various embodiments, inland water or sheltered seas or water catchment may include, but not limited to, a sheltered coast, a sheltered bay, a cove, a dam, a lake, a pond, or a reservoirs. According to various embodiments, the floating arrangement may include floating pontoons, or floating docks, or floating platforms which are configured to float on water and to support a plurality of solar panels. According to various embodiments, the floating arrangement may include a plurality of floatation units connected to each other so as to form the floating arrangement. Various embodiments have also provided a floating solar panels system whereby solar panels are mounted on the floating arrangement according to the various embodiments.

According to various embodiments, the plurality of floatation units of the floating arrangement may include at least two different types of floatation units. For example, a first type of floatation unit may include a support-floatation-unit configured for a solar panel to be mounted thereon, and a second type of floatation unit may include a connecting-floatation-unit configured for connecting or linking the various floatation units together to form the floating arrangement.

According to various embodiments, the plurality of floatation units may be configured so as to reduce the loading on the connection joints and to strengthen the floatation units such that the floating arrangement may withstand higher external forces. According to various embodiments, the support-floatation-unit for supporting solar panel may be configured to provide additional buoyancy so as to support the additional weight of the solar panel in a manner such that, when the support-floatation-unit is connected to a connecting-floatation-unit to form the floating arrangement, the additional weight of the solar panel may not be transferred to the connection joint between the support-floatation-unit and the connecting-floatation-unit.

According to various embodiments, the plurality of floatation units may also be configured to be strengthen along the respective body in a manner so as to withstand higher pulling forces between the floatation units when they are connected together.

The following examples pertain to various embodiments.

Example 1 is a floating arrangement for supporting a solar panel, including: at least one support-floatation-unit for supporting a solar panel, the support-floatation-unit including a main body having a flat base and at least one connection portion protruding sideways from a chamfered corner wall between two side walls of the main body in a direction parallel with the flat base; and at least one connecting-floatation-unit including a main body having a flat base and at least one connection portion protruding sideways from a chamfered corner wall between two side walls of the main body in a direction parallel with the flat base, wherein the at least one connection portion of the at least one support-floatation-unit is coupled to the at least one connection portion of the at least one connecting-floatation-unit to form a connection joint which connects the at least one support-floatation-unit and the at least one connecting-floatation-unit in a side-by-side arrangement, whereby one of the two side walls of the main body of the at least one support-floatation-unit abuts one of the two side walls of the main body of the at least one connecting-floatation-unit, wherein a height from the flat base of the at least one support-floatation-unit to a center of the connection joint is larger than a height from the flat base of the at least one connecting-floatation-unit to the center of the connection joint in a manner such that the flat base of the at least one support-floatation-unit extends downwards from a base level of the flat base of the at least one connecting-floatation-unit by a depth which defines an additional displacement volume of the at least one-support-floatation-unit configured to provide additional buoyancy to support the solar panel, wherein the main body of the at least one connecting-floatation unit is of an elongate shape, wherein the main body of the at least one connecting-floatation-unit including an overhanging protrusion extending longitudinally outwards from an upper half of a first longitudinal end of the main body of the at least one connecting-floatation-unit and an underside socket extending inwards at a lower half of the first longitudinal end of the main body of the at least one connecting-floatation-unit, wherein the main body of the at least one connecting-floatation-unit further including an upper-side socket extending inwards at an upper half of a second longitudinal end of the main body of the at least one-connecting-floatation-unit and a foot protrusion extending longitudinally from a lower half of the second longitudinal end of the main body of the at least one-connecting-floatation-unit.

In Example 2, the subject matter of Example 1 may optionally include: wherein respective main body of the at least one support-floatation-unit and the at least one connecting-floatation-unit includes at least one straight channel formation extending vertically upwards with respect to respective flat bases, the at least one straight channel formation being formed by an inward bend in respective one of the two side walls located adjacent to the respective chamfered corner wall having respective connection portion.

In Example 3, the subject matter of Example 2 may optionally include: wherein the at least one straight channel formation extends between the respective flat bases and respective roofs of the respective main body of the at least one support-floatation-unit and the at least one connecting-floatation-unit.

In Example 4, the subject matter of Example 3 may optionally include: wherein the at least one straight channel formation defines one continuous groove extending along an entire length of the straight channel formation without interruption.

In Example 5, the subject matter of Example 1 may optionally include: wherein respective main body of the at least one support-floatation-unit and the at least one connecting-floatation-unit includes at least one straight ridge formation extending vertically upwards with respect to respective flat bases, the at least one straight ridge formation being formed by an outward bend in respective one of the two side walls located adjacent to the respective chamfered corner wall having respective connection portion.

In Example 6, the subject matter of any one of Examples 1 to 5 may optionally include:

wherein the main body of the at least one connecting-floatation unit has four connection portions protruding from four chamfered corner walls of the main body of the at least one connecting-floatation unit, each connection portion being at a respective chamfered corner wall, wherein the main body of the at least one support-floatation-unit is of a H-shape and has four connection portions protruding from four legs of the main body of the at least one support-floatation-unit, each connection portion being at a chamfered corner wall between two side walls of an end portion of a respective leg, wherein two connection portions of two adjacent legs of the at least one support-floatation-unit are connected to two connection portions of two adjacent chamfered corner walls of the at least one connecting-floatation-unit along a longitudinal side wall of the at the at least one connecting-floatation-unit.

In Example 7, the subject matter of any one of Examples 1 to 6 may optionally include: wherein the main body of the at least one support-floatation-unit has at least one concave formation recessed into at least one side wall of the main body of the support-floatation-unit 110.

In Example 8, the subject matter of Example 7 may optionally include: wherein the main body of the at least one support-floatation-unit has at least four concave formation each recessed into at least one side wall of the main body of the support-floatation-unit 110.

In Example 9, the subject matter of any one of Examples 6 to 8 in combination with any one of Examples 2 to 4 may optionally include: wherein the main body of the at least one connecting-floatation-unit includes at least two straight channel formations, each straight channel formation being formed in respective longitudinal side walls of the main body of the at least one connecting-floatation-unit.

In Example 10, the subject matter of Example 9 may optionally include: wherein a same number of straight channel formations is formed in each longitudinal side wall of the main body of the at least one connecting-floatation-unit.

In Example 11, the subject matter of Example 9 or 10 may optionally include: wherein each straight channel formation formed in each longitudinal side wall is directly opposite another straight channel formation formed in the opposite longitudinal side wall.

In Example 12, the subject matter of Example 6 or 11 in combination with any one of Examples 2 to 4 may optionally include: wherein the main body of the at least one support-floatation unit includes at least four straight channel formations, each straight channel formation being formed in respective one of the two side walls at respective end portion of respective leg of the main body of the at least one support-floatation unit.

In Example 13, the subject matter of any one of Examples 1 to 12 may optionally include: wherein the underside socket at the first longitudinal end is shaped to correspond with a shape of the foot protrusion at the second longitudinal end, and wherein the upper-side socket at the second longitudinal end is shaped to correspond with a shape of the overhanging protrusion at the first longitudinal end.

In Example 14, the subject matter of any one of Examples 1 to 13 may optionally include: wherein, at the first longitudinal end of the main body of the at least one connecting-floatation-unit, a downward facing surface of the overhanging protrusion transit upwards to a downward facing surface of the underside socket so as to define a step profile along said transition, wherein, at the second longitudinal end of the main body of the at least one connecting-floatation-unit, an upward facing surface of the foot protrusion transit downwards to an upward facing surface of the upper-side socket so as to define a step profile along said transition.

In Example 15, the subject matter of any one of Examples 1 to 14 may optionally include: wherein the main body of the at least one connecting-floatation-unit further includes a laterally-directed-overhanging-protrusion extending laterally outwards from an upper half of a first longitudinal side wall of the main body of the at least one connecting-floatation-unit and a laterally-aligned-underside-socket extending inwards at a lower half of the first longitudinal side wall of the main body of the at least one connecting-floatation-unit.

In Example 16, the subject matter of Example 15 may optionally include: wherein, at the first longitudinal side wall of the main body of the at least one connecting-floatation-unit, a downward facing surface of the laterally-directed-overhanging-protrusion transits upwards to a downward facing surface of the laterally-aligned-underside-socket so as to define a step profile along said transition.

In Example 17, the subject matter of any one of Examples 1 to 16 may optionally include: wherein the main body of the at least one connecting-floatation-unit further includes a laterally-aligned-upper-side-socket extending inwards at an upper half of a second longitudinal side wall of the main body of the at least one connecting-floatation-unit and a laterally-directed-foot-protrusion extending laterally from a lower half of the second longitudinal side wall of the main body of the at least one connecting-floatation-unit.

In Example 18, the subject matter of Example 17 may optionally include: wherein, at the second longitudinal side wall of the main body of the at least one connecting-floatation-unit, an upward facing surface of the laterally-directed-foot-protrusion transits downwards to an upward facing surface of the laterally-aligned-upper-side-socket so as to define a step profile along said transition.

In Example 19, the subject matter of Example 17 or 18 may optionally include: wherein the laterally-aligned-underside-socket at the first longitudinal side wall is shaped to correspond with a shape of the laterally-directed-foot-protrusion at the second longitudinal side wall, and wherein the laterally-aligned-upper-side-socket at the second longitudinal side wall is shaped to correspond with a shape of the laterally-directed-overhanging-protrusion at the first longitudinal side.

In Example 20, the subject matter of any one of Examples 1 to 19 may optionally include: wherein the main body of the at least one connecting-floatation-unit further includes at least one cove formation recessed into a longitudinal side of the main body of the at least one connecting-floatation-unit.

In Example 21, the subject matter of Example 20 may optionally include: wherein the main body of the at least one connecting-floatation-unit further includes at least two cove formations, each recessed into respective longitudinal sides of the main body of the at least one connecting-floatation-unit.

In Example 22, the subject matter of Example 20 or 21 may optionally include: wherein the main body of the at least one connecting-floatation-unit further includes at least one laterally-directed-connection-portion protruding away from each cove formation.

In Example 23, the subject matter of any one of Examples 1 to 22 may optionally include: wherein the main body of the at least one connecting-floatation-unit includes one or more hollow tube formations extending perpendicularly from a roof of the main body to the flat base of the main body in a manner so as to form a through-hole from the roof of the main body to the flat base of the main body.

In Example 24, the subject matter of any one of Examples 1 to 23 may optionally include: wherein each main body of the at least one support-floatation-unit and the at least one connecting-floatation-unit includes a hollow watertight container.

In Example 25, the subject matter of any one of Examples 1 to 24 may optionally include: wherein each connection portion of the at least one support-floatation-unit and the at least one connecting-floatation-unit includes a connection lug with respective eyehole axis being perpendicular to respective flat base.

In Example 26, the subject matter of Example 25 may optionally include: wherein the connection lug of the at least one support-floatation-unit and the connection lug of the at least one connecting-floatation-unit are coupled together with a nut and bolt to form the connection joint.

Example 27 is a floating solar panel system including: the floating arrangement according to any one of Examples 1 to 26, and at least one solar panel mounted to the at least one support-floatation-unit.

Example 28 is a connecting-floatation-unit, including: a main body having a flat base and at least one connection portion protruding sideways from a chamfered corner wall between two side walls of the main body in a direction parallel with the flat base, wherein the main body of the connecting-floatation unit is of an elongate shape, wherein the main body of the connecting-floatation-unit includes an overhanging protrusion extending longitudinally outwards from an upper half of a first longitudinal end of the main body of the connecting-floatation-unit and an underside socket extending inwards at a lower half of the first longitudinal end of the main body of the connecting-floatation-unit, wherein the main body of the connecting-floatation-unit further includes an upper-side socket extending inwards at an upper half of a second longitudinal end of the main body of the at least one-connecting-floatation-unit and a foot protrusion extending longitudinally from a lower half of the second longitudinal end of the main body of the at least one-connecting-floatation-unit.

In Example 29, the subject matter of Example 28 may optionally include: wherein main body of the connecting-floatation-unit includes at least one straight channel formation extending vertically upwards with respect to the flat base, the at least one straight channel formation being formed by an inward bend in one of the two side walls located adjacent to the chamfered corner wall having the at least one connection portion.

In Example 30, the subject matter of Example 29 may optionally include: wherein the at least one straight channel formation extends between the flat base and a roof of the main body of the connecting-floatation-unit.

In Example 31, the subject matter of Example 30 may optionally include: wherein the at least one straight channel formation defines one continuous groove extending along an entire length of the straight channel formation without interruption.

In Example 32, the subject matter of Example 28 may optionally include: wherein the main body of the connecting-floatation-unit includes at least one straight ridge formation extending vertically upwards with respect to the flat base, the at least one straight ridge formation being formed by an outward bend in one of the two side walls located adjacent to the chamfered corner wall having the at least one connection portion.

In Example 33, the subject matter of Example 28 to 32 may optionally include: wherein the main body of the connecting-floatation unit has four connection portions protruding from four chamfered corner walls of the main body of the connecting-floatation unit, each connection portion being at a respective chamfered corner wall.

In Example 34, the subject matter of Example 28 to 33 may optionally include: wherein the main body of the connecting-floatation-unit includes at least two straight channel formations, each straight channel formation being formed in respective longitudinal side walls of the main body of the connecting-floatation-unit.

In Example 35, the subject matter of Example 34 may optionally include: wherein a same number of straight channel formations is formed in each longitudinal side wall of the main body of the connecting-floatation-unit.

In Example 36, the subject matter of any one of Example 34 or 35 may optionally include: wherein each straight channel formation formed in each longitudinal side wall is directly opposite another straight channel formation formed in the opposite longitudinal side wall.

In Example 37, the subject matter of any one of Examples 28 to 36 may optionally include: wherein the underside socket at the first longitudinal end is shaped to correspond with a shape of the foot protrusion at the second longitudinal end, and wherein the upper-side socket at the second longitudinal end is shaped to correspond with a shape of the overhanging protrusion at the first longitudinal end.

In Example 38, the subject matter of Example 28 to 37 may optionally include: wherein, at the first longitudinal end of the main body of the connecting-floatation-unit, a downward facing surface of the overhanging protrusion transit upwards to a downward facing surface of the underside socket so as to define a step profile along said transition, wherein, at the second longitudinal end of the main body of the connecting-floatation-unit, an upward facing surface of the foot protrusion transit downwards to an upward facing surface of the upper-side socket so as to define a step profile along said transition.

In Example 39, the subject matter of any one of Examples 28 to 38 may optionally include: wherein the main body of the connecting-floatation-unit further includes a laterally-directed-overhanging-protrusion extending laterally outwards from an upper half of a first longitudinal side wall of the main body of the connecting-floatation-unit and a laterally-aligned-underside-socket extending inwards at a lower half of the first longitudinal side wall of the main body of the connecting-floatation-unit.

In Example 40, the subject matter of Example 39 may optionally include: wherein, at the first longitudinal side wall of the main body of the connecting-floatation-unit, a downward facing surface of the laterally-directed-overhanging-protrusion transits upwards to a downward facing surface of the laterally-aligned-underside-socket so as to define a step profile along said transition.

In Example 41, the subject matter of any one of Examples 28 to 40 may optionally include: wherein the main body of the connecting-floatation-unit further includes a laterally-aligned-upper-side-socket extending inwards at an upper half of a second longitudinal side wall of the main body of the connecting-floatation-unit and a laterally-directed-foot-protrusion extending laterally from a lower half of the second longitudinal side wall of the main body of the connecting-floatation-unit.

In Example 42, the subject matter of Example 41 may optionally include: wherein, at the second longitudinal side wall of the main body of the connecting-floatation-unit, an upward facing surface of the laterally-directed-foot-protrusion transits downwards to an upward facing surface of the laterally-aligned-upper-side-socket so as to define a step profile along said transition.

In Example 43, the subject matter Examples 41 or 42 may optionally include: wherein the laterally-aligned-underside-socket at the first longitudinal side wall is shaped to correspond with a shape of the laterally-directed-foot-protrusion at the second longitudinal side wall, and wherein the laterally-aligned-upper-side-socket at the second longitudinal side wall is shaped to correspond with a shape of the laterally-directed-overhanging-protrusion at the first longitudinal side wall.

In Example 44, the subject matter of any one of Examples 28 to 43 may optionally include: wherein the main body of the connecting-floatation-unit further includes at least one cove formation recessed into a longitudinal side of the main body of the connecting-floatation-unit.

In Example 45, the subject matter of any one of Example 44 may optionally include: wherein the main body of the connecting-floatation-unit further includes at least two cove formations, each recessed into respective longitudinal sides of the main body of the connecting-floatation-unit.

In Example 46, the subject matter of any one of Examples 44 or 45 may optionally include: wherein the main body of the connecting-floatation-unit further includes at least one laterally-directed-connection-portion protruding away from each cove formation.

In Example 47, the subject matter of any one of Examples 28 to 46 may optionally include: wherein the main body of the connecting-floatation-unit includes one or more hollow tube formations extending perpendicularly from a roof of the main body to the flat base of the main body in a manner so as to form a through-hole from the roof of the main body to the flat base of the main body.

In Example 48, the subject matter of any one of Examples 28 to 47 may optionally include: wherein each main body of the connecting-floatation-unit includes a hollow watertight container.

In Example 49, the subject matter of any one of Examples 28 to 48 may optionally include:

wherein each connection portion of the connecting-floatation-unit includes a connection lug with respective eyehole axis being perpendicular to the flat base.

Example 50 is a support-floatation-unit for supporting a solar panel, including a main body having a flat base and at least one connection portion protruding sideways from a chamfered corner wall between two side walls of the main body in a direction parallel with the flat base, wherein the main body of the support-floatation-unit is of a H-shape.

In Example 51, the subject matter of Example 50 may optionally include: wherein the main body of the at least one support-floatation-unit has at least one concave formation recessed into at least one side wall of the main body of the support-floatation-unit.

In Example 52, the subject matter of Example 51 may optionally include: wherein the main body of the at least one support-floatation-unit has at least four concave formation each recessed into at least one side wall of the main body of the support-floatation-unit.

In Example 53, the subject matter of any one of Examples 50 to 52 may optionally include: wherein respective main body of the support-floatation-unit comprises at least one straight channel formation extending vertically upwards with respect to the flat base, the at least one straight channel formation being formed by an inward bend in one of the two side walls located adjacent to the chamfered corner wall having the at least one connection portion.

In Example 54, the subject matter of Example 53 may optionally include: wherein the at least one straight channel formation extends between the flat base and a roof of the main body of the support-floatation-unit.

In Example 55, the subject matter of Example 50 may optionally include: wherein respective main body of the support-floatation-unit comprises at least one straight ridge formation extending vertically upwards with respect to the flat base, the at least one straight ridge formation being formed by an outward bend in one of the two side walls located adjacent to the chamfered corner wall having the at least one connection portion.

In Example 56, the subject matter of any one of Examples 50 to 55 may optionally include: wherein the main body of the support-floatation-unit has four connection portions protruding from four legs of the main body of the support-floatation-unit, each connection portion being at a chamfered corner wall between two side walls of an end portion of a respective leg.

In Example 57, the subject matter of any one of Examples 50 to 56 may optionally include: wherein the main body of the support-floatation-unit comprises at least four straight channel formations, each straight channel formation being formed in respective one of the two side walls at respective end portion of respective leg of the main body of the support-floatation-unit.

In Example 58, the subject matter of any one of Examples 50 to 57 may optionally include: wherein the main body of the support-floatation-unit comprises a hollow watertight container.

In Example 59, the subject matter of any one of Examples 50 to 58 may optionally include: wherein each connection portion of the support-floatation-unit comprises a connection lug with respective eyehole axis being perpendicular to the flat base.

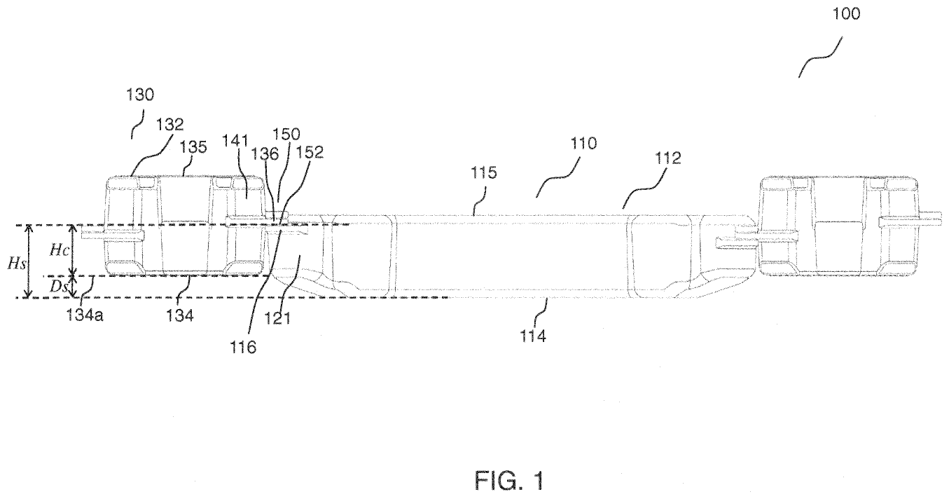

FIG. 1 shows a side view of a floating arrangement 100 for supporting a solar panel according to various embodiments. As shown, the floating arrangement 100 includes at least one support-floatation-unit 110 and at least one connecting-floatation-unit 130. According to various embodiments, the at least one support-floatation-unit 110 may be configured to support or hold a solar panel (not shown). The at least one support-floatation-unit 110 may include mounting portions to which the solar panel may be mounted. According to various embodiments, the at least one connecting-floatation-unit 130 may be configured for connecting to the at least one support-floatation-unit 110 or to another connecting-floatation-unit 130 such that the floating arrangement 100 may be formed. Accordingly, the at least one connecting-floatation-unit may be the links or the frames of the floating arrangement 100. According to various embodiments, the at least one connecting-floatation-unit 130 may also be configured to serve as pathways for a person to access the solar panels mounted to the floating arrangement 100 for maintenance, repairs, servicing and/or installations.

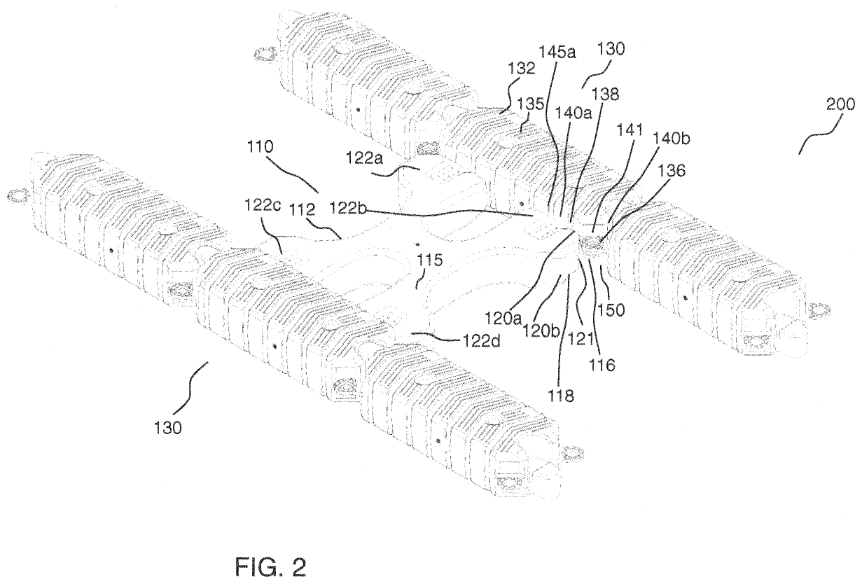

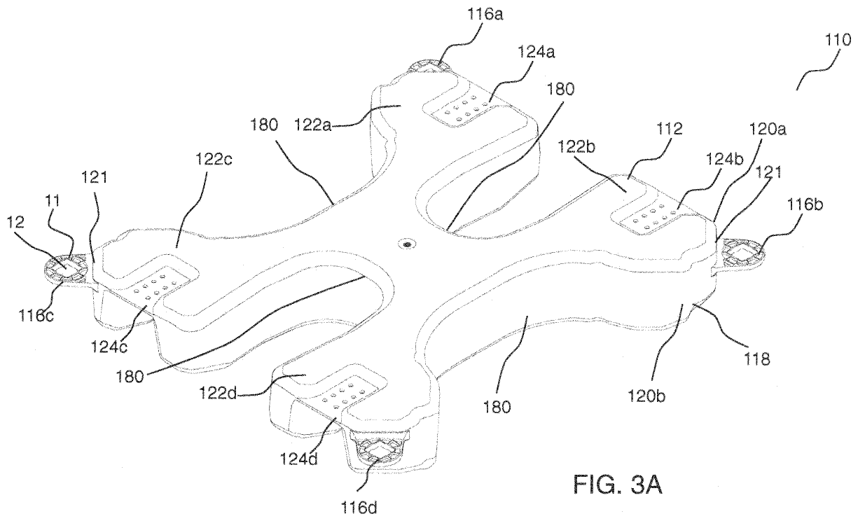

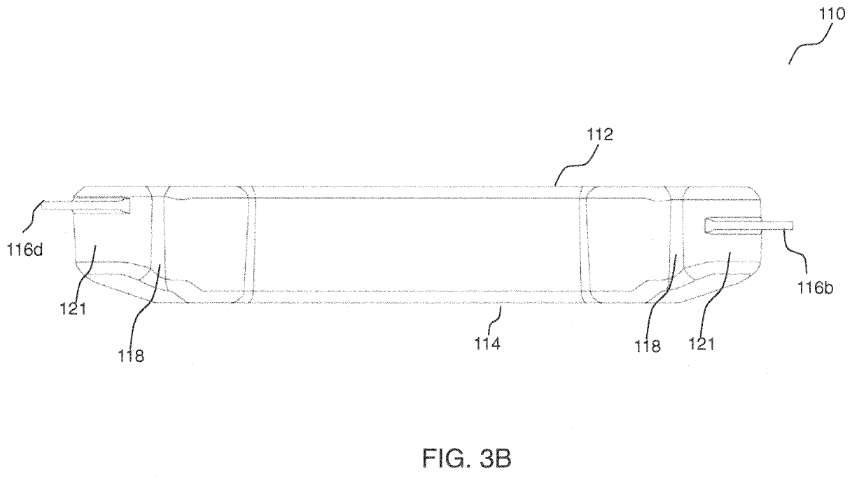

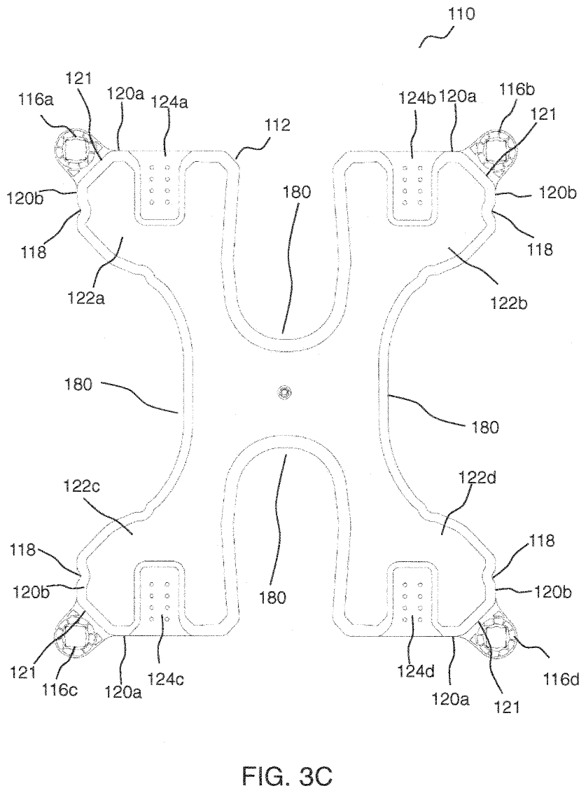

As shown in FIG. 1, the at least one support-floatation-unit 110 has a main body 112 having a flat base 114, a roof 115 (or deck, ceiling etc.) opposite the flat base 114, and at least one connection portion (or corner-connection-portion) 116 protruding sideways from a chamfered corner wall 121 between two side walls 120a, 120b (see FIG. 2) of the main body 112. The at least one connection portion (or corner-connection-portion) 116 is protruding in a direction along a plane parallel with the flat base 114. The two side walls 120a, 120b are extending perpendicularly upwards from the flat base 114 towards the roof 115. Each of the side walls 120a, 120b may extend between a corresponding edge of the flat base 114 and a corresponding edge of the roof 115. Accordingly, the side walls 120a, 120b may be upright walls extending between the flat base 114 and the roof 115. According to various embodiments, the main body 112 may include a hollow watertight container so as to be floatable on water. According to various embodiments, the at least one connection portion (or corner-connection-portion) 116 may include a connection lug 11 with an eyehole 12 (see FIG. 3A) such that the connection lug 11 may be placed together with a connection lug of another floatation unit so as to connect the two floatation units together. According to various embodiments, the connection lug 11 may be protruding in a lateral direction from the chamfered corner wall 121 which is extending perpendicularly upwards from the flat base 114. According to various embodiments, the eyehole 12 of the connection lug 11 may have an eyehole axis which is perpendicular to the flat base 114. Accordingly, the connection lug 11 may be oriented with the eyehole axis extending vertically with respect to the flat base 114.

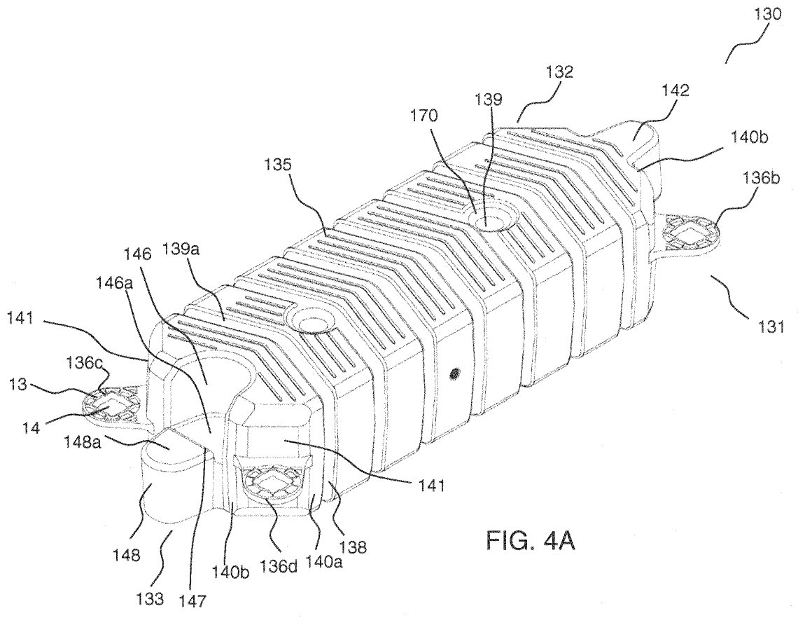

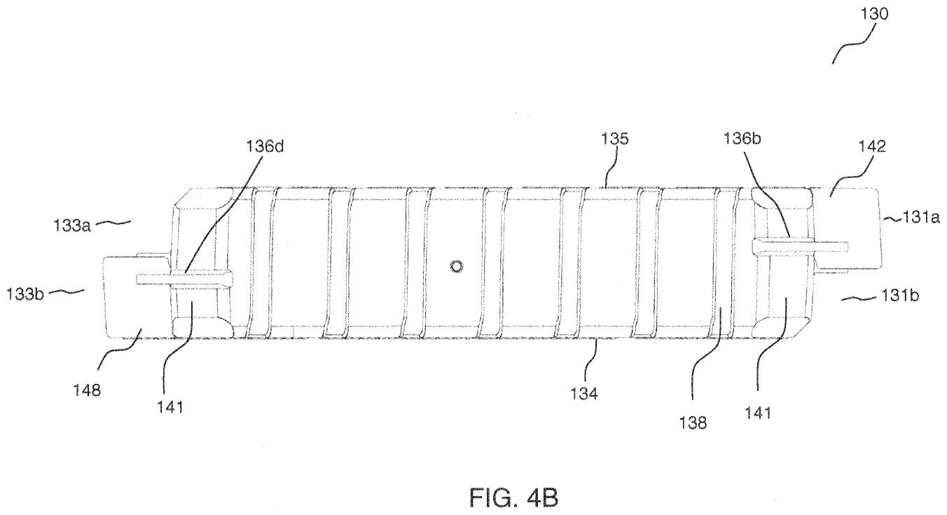

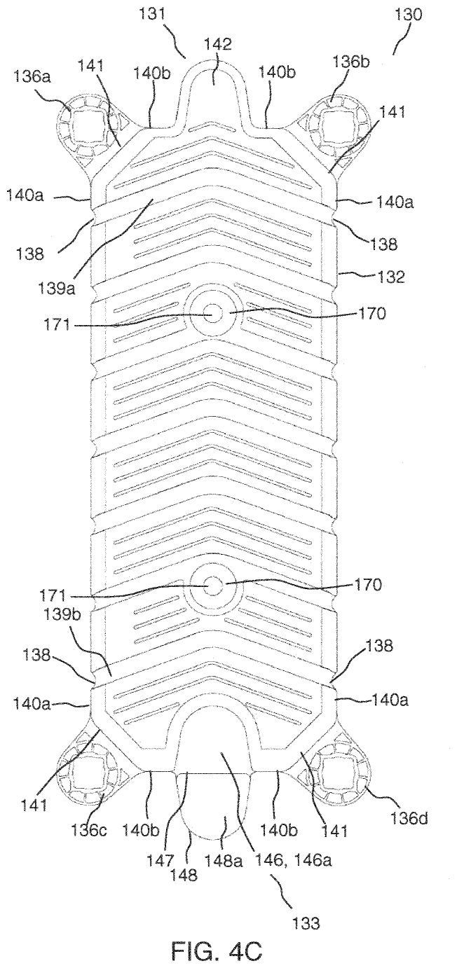

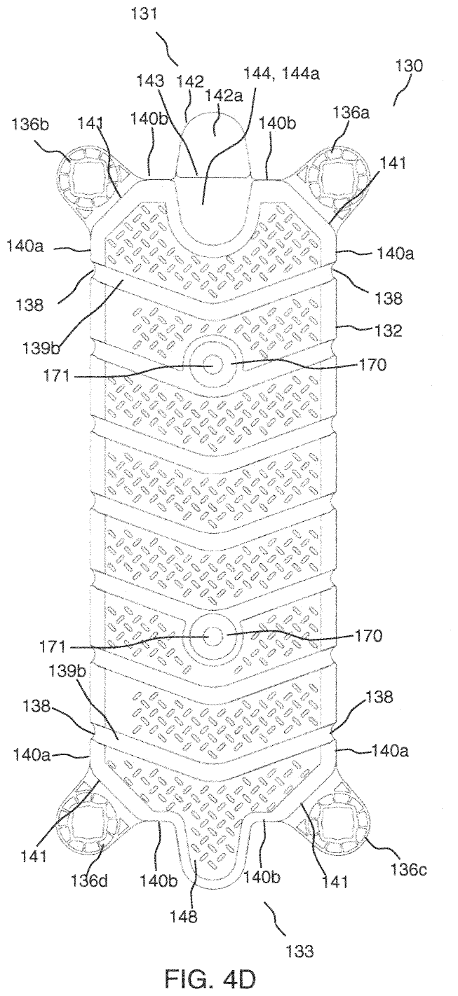

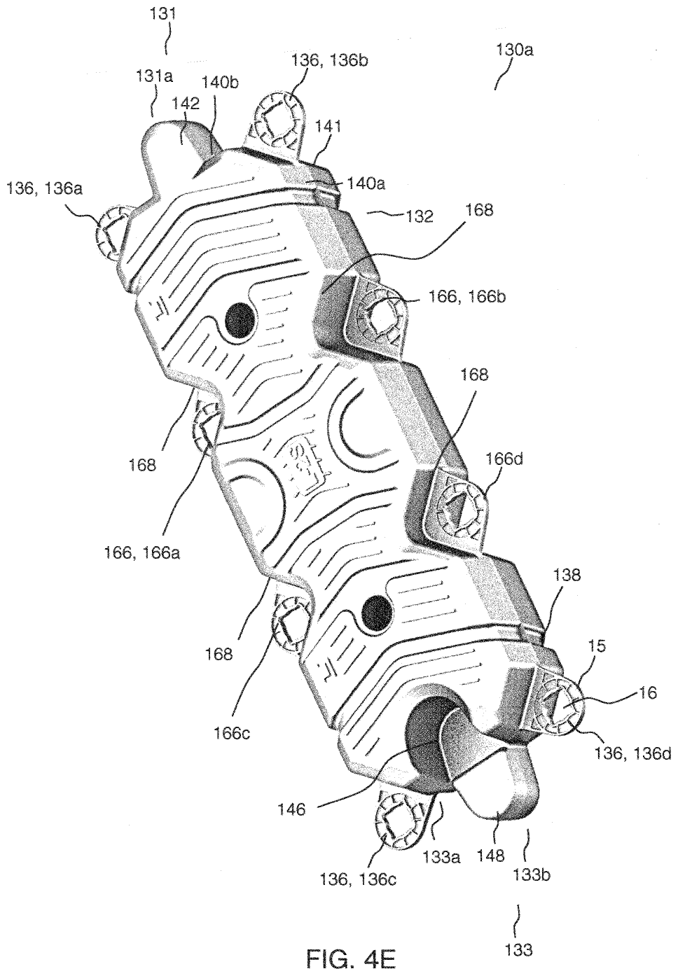

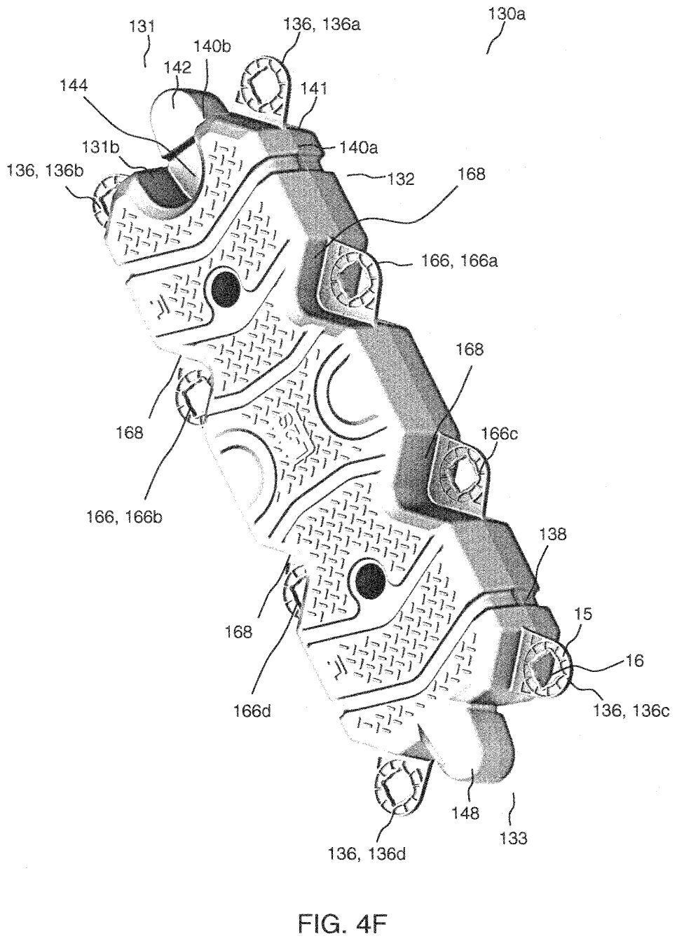

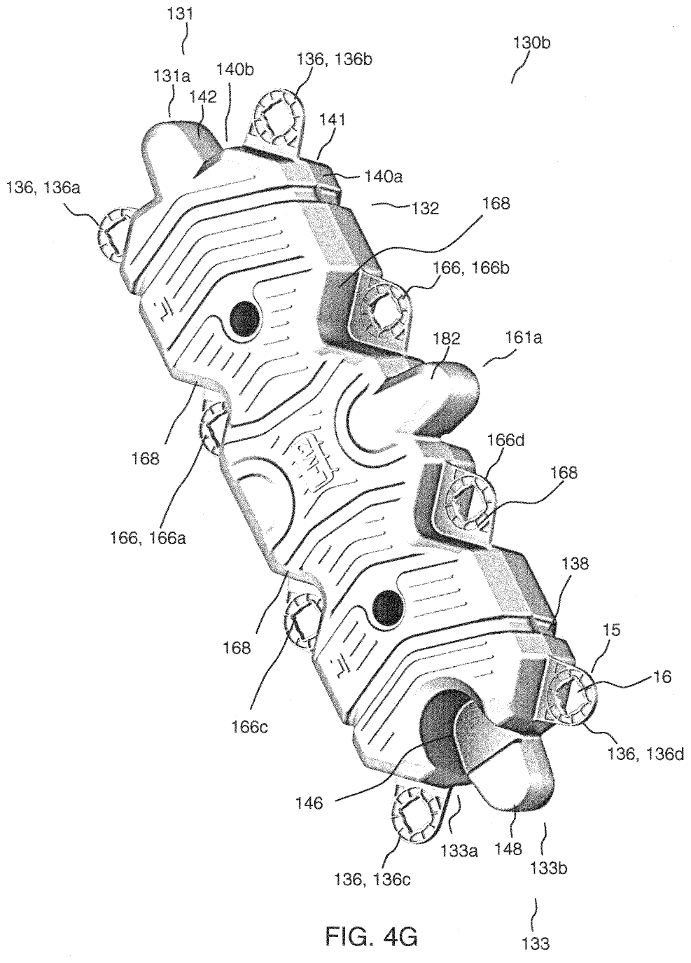

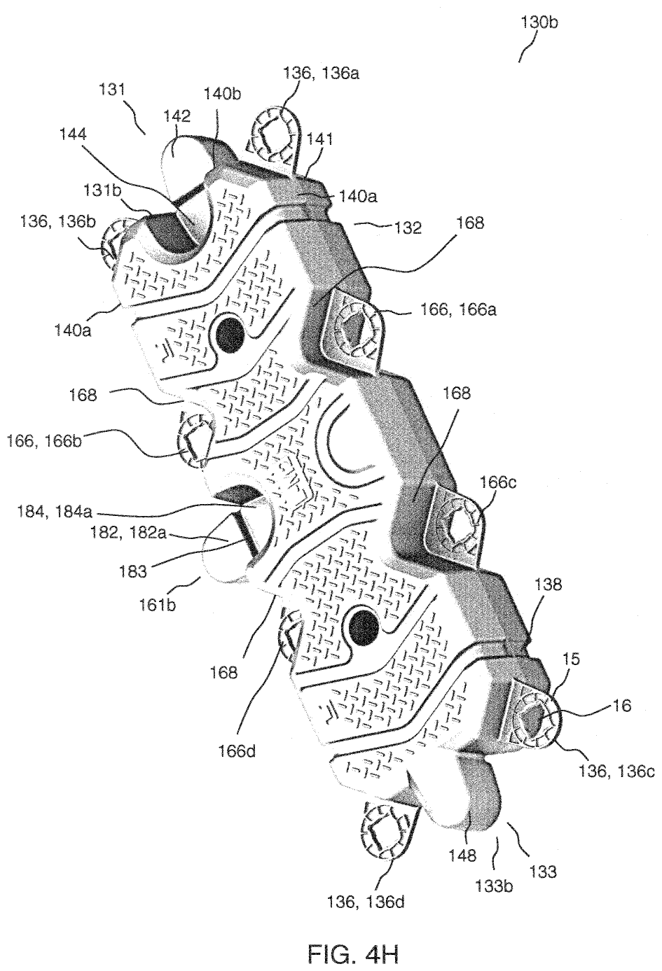

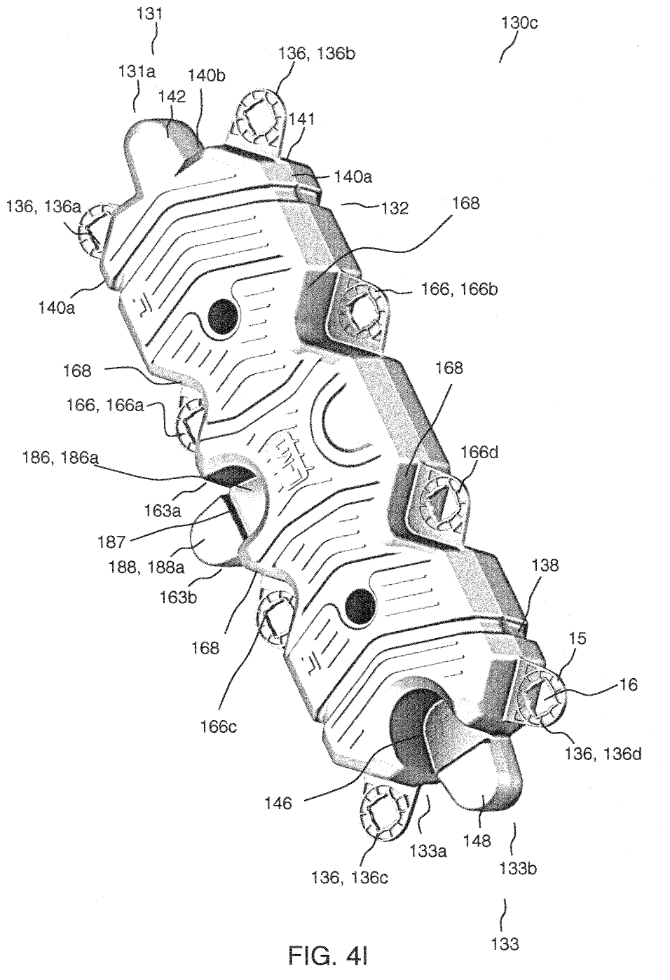

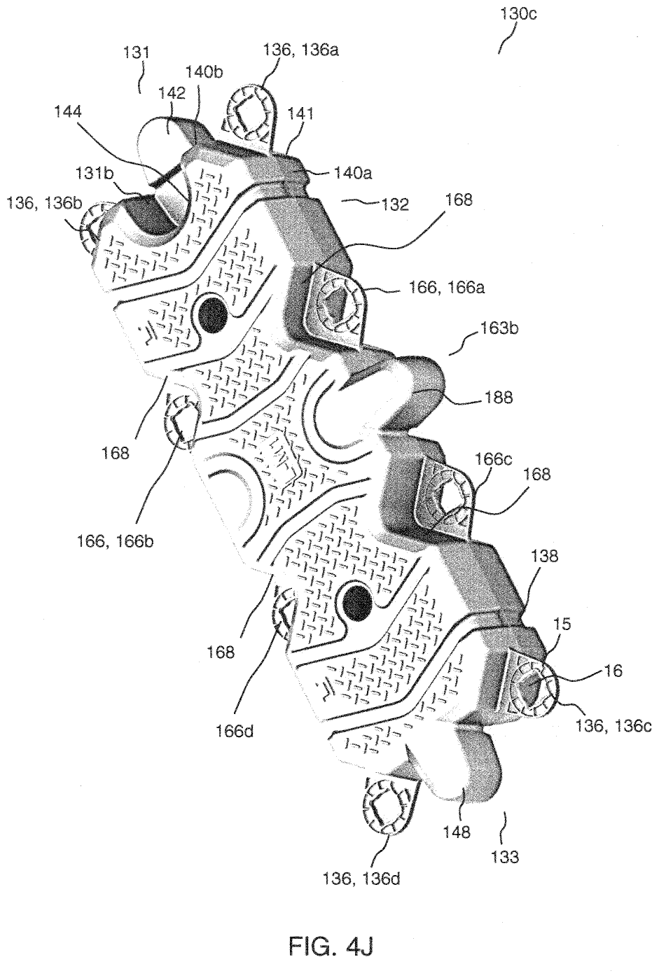

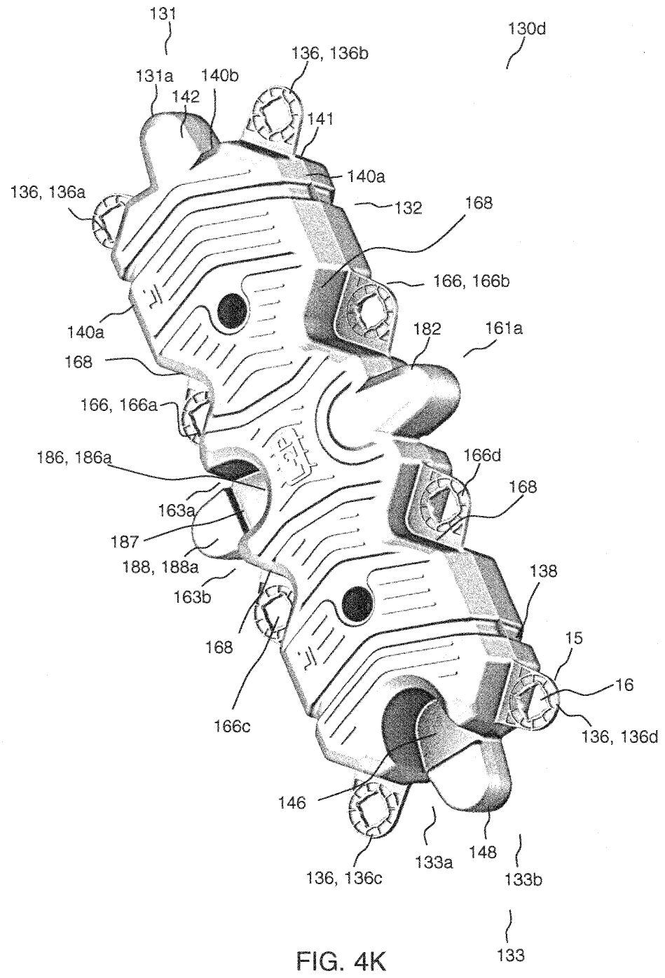

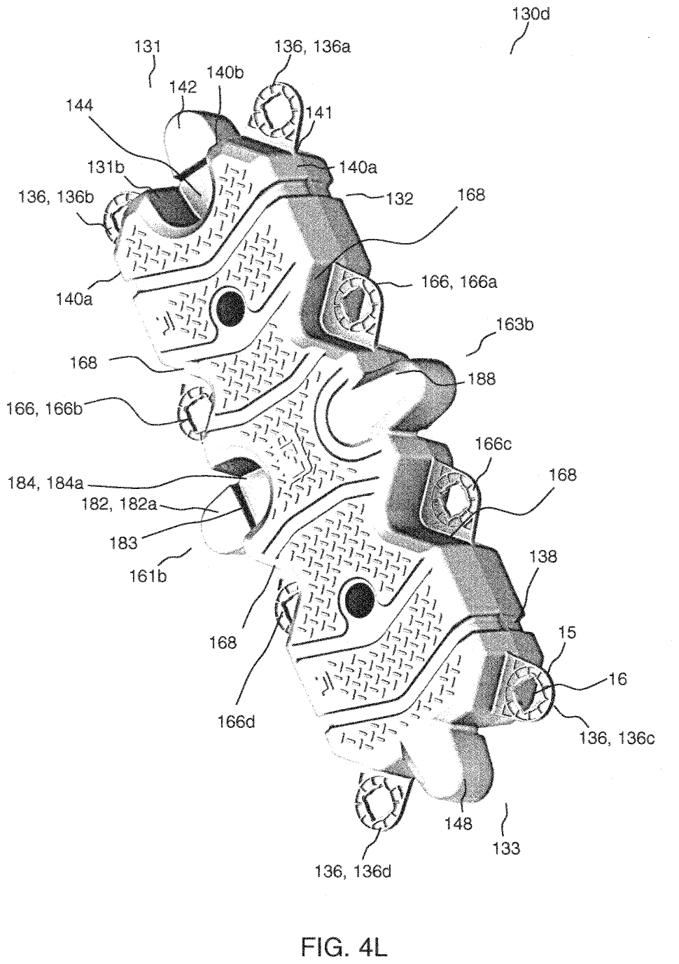

As also shown in FIG. 1, the at least one connecting-floatation-unit 130 has a main body (or elongate main body) 132 having a flat base (or elongate flat base) 134, an elongate roof 135 (or deck, ceiling etc.) opposite the flat base (or elongate flat base) 134, and two opposite longitudinal side walls 140a and two opposite lateral side walls 140b. The at least one connecting-floatation-unit 130 also has at least one connection portion (or corner-connection-portion) 136 protruding sideways from a chamfered corner wall 141 between two side walls 140a, 140b (or a pair of adjacent longitudinal and lateral side walls 140a, 140b, e.g. see FIG. 2) of the main body (or elongate main body) 132. The at least one connection portion (or corner-connection-portion) 136 is protruding in a direction along a plane parallel with the flat base (or elongate flat base) 134. The side walls 140a, 140b are extending perpendicularly upwards from the flat base (or elongate flat base) 134 towards the elongate roof 135. Each of the two longitudinal side walls 120a and the two lateral side walls 140b may extend between a corresponding edge of the flat base (or elongate flat base) 134 and a corresponding edge of the elongate roof 135. Accordingly, the longitudinal side walls 140a and the lateral side walls 140b may be upright walls extending between the flat base (or elongate flat base) 134 and the elongate roof 135. According to various embodiments, the main body (or elongate main body) 132 may, similar to the main body 112 of the at least one support-floatation-unit 110, include a hollow watertight container so as to be floatable on water. According to various embodiments, the at least one connection portion (or corner-connection-portion) 136 may, similar to the at least one connection portion (or corner-connection-portion) 116 of the at least one support-floatation-unit 110, include a connection lug 13 with an eyehole 14 (see FIG. 4A) such that the connection lug 13 may be placed together with a connection lug of another floatation unit so as to connect the two floatation units together. According to various embodiments, the connection lug 13 may be protruding in a lateral direction from the chamfered corner wall 141 which is extending perpendicularly upwards from the flat base (or elongate flat base) 134. According to various embodiments, the eyehole 14 of the connection lug 13 may have an eyehole axis which is perpendicular to the flat base (or elongate flat base) 134. Accordingly, the connection lug 13 may be oriented with the eyehole axis extending vertically with respect to the flat base (or elongate flat base) 134.

As shown in FIG. 1, in the floating arrangement 100, the at least one connection portion (or corner-connection-portion) 116 of the at least one support-floatation-unit 110 is coupled to the at least one connection portion (or corner-connection-portion) 136 of the at least one connecting-floatation-unit 130 to form a connection joint 150 which connects the at least one support-floatation-unit 110 and the at least one connecting-floatation-unit 130 in a side-by-side arrangement, whereby one of the two side walls 120a, 120b of the main body 112 of the at least one support-floatation-unit 110 abuts the longitudinal side wall 140a of the main body (or elongate main body) 132 of the at least one connecting-floatation-unit 130. According to various embodiments, the at least one connection portion (or corner-connection-portion) 116 of the at least one support-floatation-unit 110 may be fixedly coupled to the at least one connection portion (or corner-connection-portion) 136 of the at least one connecting-floatation-unit 130. Accordingly, the at least one support-floatation-unit 110 and the at least one connecting-floatation-unit 130 may be firmly attached in a manner so as to prevent relative movement between the at least one support-floatation-unit 110 and the at least one connecting-floatation-unit 130. According to various embodiments, when the at least one connection portion (or corner-connection-portion) 116 of the at least one support-floatation-unit 110 and the at least one connection portion (or corner-connection-portion) 136 of the at least one connecting-floatation-unit 130 are connection lugs 11, 13, the at least one connection portion (or corner-connection-portion) 116 of the at least one support-floatation-unit 110 and the at least one connection portion (or corner-connection-portion) 136 of the at least one connecting-floatation-unit 130 may be placed in an overlapping manner with the respective eyeholes 12, 14 aligned, and a bolt may be inserted therethrough with a nut screwed onto the bolt from the other end of the bolt to clamp the connection lugs 11, 13 together. Accordingly, the connection joint 150 may include a bolt and a nut clamping or sandwiching the at least one connection portion (or corner-connection-portion) 116 (or connection lug 11) of the at least one support-floatation-unit 110 and the at least one connection portion (or corner-connection-portion) 136 (or connection lug 13) of the at least one connecting-floatation-unit 130 together. According to various embodiments, the connection joint 150 may connect the at least one support-floatation-unit 110 and the at least one connecting-floatation-unit 130 alongside each other so as to form the side-by-side arrangement. According to various embodiments, in the side-by-side arrangement, the side wall 120a of the main body 112 of the at least one support-floatation-unit 110, which may be a short side thereof, may be abutting the side wall 140a of the main body (or elongate main body) 132 of the at least one connecting-floatation-unit 130, which may be a long side thereof.

Referring to FIG. 1, in the floating arrangement 100 with the at least one connection portion (or corner-connection-portion) 116 of the at least one support-floatation-unit 110 and the at least one connection portion (or corner-connection-portion) 136 of the at least one connecting-floatation-unit 130 coupled together, a height, Hs, from the flat base 114 of the at least one support-floatation-unit 110 to a center 152 of the connection joint 150 is larger than a height, Hc, from the flat base (or elongate flat base) 134 of the at least one connecting-floatation-unit 130 to the center 150 of the connection joint 150. Accordingly, the flat base 114 of the at least one support-floatation-unit 110 extends downwards from a base level 134a of the flat base (or elongate flat base) 134 of the at least one connecting-floatation-unit 130 by a depth, Ds. According to various embodiments, the depth, Ds, may define an additional displacement volume of the at least one support-floatation-unit 110 configured to provide additional buoyancy to support the solar panel. According to various embodiments, the additional buoyancy may correspond to a portion of a weight of the solar panel, for example, the additional buoyancy may correspond to at least half of the weight of the solar panel, or at least two-third of the weight of the solar panel, or at least three-quarter of the weight of the solar panel, or substantially the weight of the solar panel.

In conventional floating system for supporting solar panels, various conventional floatation units (including support-floatation-units for supporting solar panels and connecting-floatation-units) forming the floating system are configured in a manner such that, when the various conventional floatation units are rigidly coupled together, the base of the various conventional floatation units are flushed and levelled. Accordingly, when solar panels are mounted on the conventional floating system, the additional weight of the solar panels are distributed to the various conventional floatation units through the connection joints such that the entire floating system may sink deeper together as a whole so as to displaced additional volume of water to provide additional buoyancy to support the solar panels. Hence, in the conventional floating system, the connection joint would serve to transfer the load from the weight of the solar panels for distribution to the various conventional floatation units when the solar panels are installed. Accordingly, the connection joint of the conventional floating system is constantly under load. In contrast, according to various embodiments, the floating arrangement 100 differs from the conventional floating system in that the at least one support-floatation-unit 110 of the floating arrangement 100 may sink deeper than the adjacently coupled at least one connecting-floatation-unit 130 when the solar panel is mounted on the at least one support-floatation-unit 110 such that the at least one support-floatation-unit 110, itself, may provide additional buoyancy to support the solar panel. Accordingly, in this manner, the floating arrangement 100 according to the various embodiments may minimize or eliminate the transferring of load via connection joints between floatation units for the distribution of the weight of the solar panel to other floatation units. Hence, the loading on the connection joint 150 between the at least one support-floatation-unit 110 and the at least one connecting-floatation-unit 130 in the floating arrangement 100 according to the various embodiments may in turn be minimized or eliminated when the solar panel is mounted on the at least one support-floatation-unit 110. Thus, the connection joint 150 between the at least one support-floatation-unit 110 and the at least one connecting-floatation-unit 130 may be preserved for and may be more effective in transferring load from external forces due to wind and/or sea wave and/or tidal forces.

FIG. 2 shows a perspective view of a floating arrangement 200 according to various embodiments. As shown, the floating arrangement 200 may include two rows of three interconnected connecting-floatation-unit 130 and one support-floatation-unit 110 connected between the two rows of connecting-floatation-unit 130. According to various embodiments, a floating arrangement may include any number of connecting-floatation-units 130 and support-floatation-units 110, and they may be connected in any configuration. According to various embodiments, a floating arrangement for supporting solar panels may include at least one support-floatation-unit for supporting a solar panel and at least one connecting-floatation-unit, or may include one or more support-floatation-units and one or more connecting-floatation-units, or may include a plurality of support-floatation-units and a plurality of support-floatation-units.

Referring to FIG. 2, respective main body 112, 132 of the at least one support-floatation-unit 110 and the at least one connecting-floatation-unit 130 may include at least one straight channel formation 118, 138 extending vertically (or perpendicularly or substantially perpendicularly) upwards with respect to respective flat bases 114, 134. According to various embodiments, the at least one straight channel formation 118, 138 of the respective main body 112, 132 of the at least one support-floatation-unit 110 and the at least one connecting-floatation-unit 130 may extend from the respective flat bases 114, 134 to the respective roofs 115, 135. That is, the at least one straight channel formation 118, 138 may have a starting point (or begins) at the respective flat bases 114, 134 and has an ending point (or terminates) at the respective roofs 115, 135. In other words, the at least one straight channel formation 118, 138 may run along an entire height (or thickness) of the respective main body 112, 132 of the at least one support-floatation-unit 110 and the at least one connecting-floatation-unit 130. According to various embodiments, the at least one straight channel formation 118, 138 may be formed by an inward bend in respective one of the two side walls 120a, 120b, 140a, 140b located adjacent to the respective chamfered corner 121, 141 from which the respective connection portion (or corner-connection-portion) 116, 136 is protruding. Accordingly, the at least one straight channel formation 118, 138 may be formed in the respective one of the two side walls 120a, 120b, 140a, 140b in a manner such that the at least one straight channel formation 118, 138 may be running perpendicularly upwards along the respective one of the two side walls 120a, 120b, 140a, 140b from the respective flat base 114, 134 to the respective roofs 115, 135. According to various embodiments, the at least one straight channel formation 118, 138 may resemble a groove or an elongate indentation or a debossed channel from an exterior surface of the respective main body 112, 132, and may resemble a ridge or a rib from an interior surface of the respective main body 112, 132.

According to various embodiments, the at least one straight channel formation 118, 138 may strengthen the respective main body 112, 132 so as to withstand higher horizontal tension loading. Accordingly, in the floating arrangement 100 of FIG. 1 or the floating arrangement 200 of FIG. 2, the respective main body 112, 132 of the respective at least one support-floatation-unit 110 and the at least one connecting-floatation-unit 130 may be able to withstand higher tension forces pulling the respective units apart. According to various embodiments, the tension forces may be due to wind and/or sea wave and/or tidal forces.

According to various embodiments, in the floating arrangement 200, at least one straight channel formation 118 may be included (or formed) in the side wall 120b of the main body 112 of the at least one support-floatation-unit 110 and at least one straight channel formation 138 may be included (or formed) in the side wall 140a of the main body (or elongate main body) 132 of the at least one connecting-flotation-unit 130. Accordingly, in the floating arrangement unit 200, the at least one straight channel formations 118, 138 may be respectively included in side walls 120b, 140a that are orthogonal to each other. Accordingly, when the floating arrangement 200 has at least one straight channel formation 118, 138 respectively included (or formed) in side walls 120b, 140a, the respective main body 112, 132 of the floating arrangement 200 may be able to withstand higher tension forces acting on the floating arrangement 200 along both a longitudinal direction and a lateral direction or transverse direction of the floating arrangement 200.

According to various embodiments (not shown), instead of the at least one straight channel formation 118, 138, respective main body 112, 132 of the at least one support-floatation-unit 110 and the at least one connecting-floatation-unit 130 may include at least one straight ridge formation (not shown) extending vertically (or perpendicularly) upwards with respect to respective flat bases 114, 134. According to various embodiments, the at least one straight ridge formation may be formed by an outward bend in respective one of the two side walls 120a, 120b, 140a, 140b located adjacent to the respective chamfered corner 121, 141 from which the respective connection portion (or corner-connection-portion) 116, 136 is protruding. Accordingly, the at least one straight ridge formation 118, 138 may be formed in respective one of the two side walls 120a, 120b, 140a, 140b in a manner such that the at least one straight ridge formation 118, 138 may be running perpendicularly upwards along the respective one of the two side walls 120a, 120b, 140a, 140b from the respective flat base 114, 134 to the respective roofs 115, 135. According to various embodiments, the at least one straight ridge formation 118, 138 may resemble a groove or an elongate indentation or a debossed channel from an interior surface of the respective main body 112, 132, and may resemble a rib from an exterior surface of the respective main body 112, 132.

FIG. 3A to FIG. 3C show a perspective view, a side view and a top view of the support-floatation-unit 110 of the floating arrangement 100 of FIG. 1 and the floating arrangement 200 of FIG. 2 according to various embodiments.

As shown in FIG. 3A and FIG. 3C, the main body 112 of the support-floatation-unit 110 is of a H-shape. According to various embodiments, the support-floatation-unit 110 may include four legs 122a, 122b, 122c, 122d. According to various embodiments, a first and second legs 122a, 122b may be directed in a first direction and a third and fourth legs 122c, 122d may be directed in a second direction, whereby the first direction and the second direction are opposite directions. As shown, the main body 112 of the support-floatation-unit 110 has four connection portions (or corner-connection-portions) 116a, 116b, 116c, 116d protruding from the four legs 122a, 122b, 122c, 122d of the main body 112 of the at least one support-floatation-unit 110. Accordingly, each connection portion (or corner-connection-portion) 116a, 116b, 116c, 116d is at a chamfered corner wall 121 between two side walls 120a, 120b of an end portion of a respective leg 122a, 122b, 122c, 122d. According to various embodiments, each connection portion (or corner-connection-portion) 116a, 116b, 116c, 116d may be protruding sideways from the chamfered corner wall 121 at the end portion of a respective leg 122a, 122b, 122c, 122d of the main body 112. According to various embodiments, the connection portions (or corner-connection-portions) 116a, 116b of the first and second legs 122a, 122b may be at a same first level, and the connection portions (or corner-connection-portions) 116c, 116d of the third and fourth legs 122c, 122d may be at a same second level, whereby the first level and the second level are at a different height with respect to the flat base 114 of the support-floatation-unit 110.

The main body 112 of the support-floatation-unit 110 may have at least one concave formation 180 recessed into at least one side wall of the main body 112 of the support-floatation-unit 110. According to various embodiments, each concave formation may be a segment of the at least one side wall of the main body 112 having a profile that curves inward like an interior of a circle. According to various embodiments, the at least one concave formation 180 may be located along a middle segment of the at least one side wall of the main body 112 between two oppositely extending legs, for example a transition between the first leg 122a and the third leg 122c and/or a transition between the second leg 122b and the fourth leg 122d. According to various embodiments, the at least one concave formation 180 may be located along one side wall of the linking portion of the H-shaped main body 112, for example the side wall of the linking portion of the H-shaped main body 112 joining the first leg 112a and the second leg 112b and/or the side wall of the linking portion of the H-shaped main body 112 joining the third leg 112c and the fourth leg 112d. Preferably, the main body 112 of the support-floatation-unit 110 has at least four concave formations 180, each of the at least four concave formations 180 recessed into a respective side wall of the main body 112 of the support-floatation-unit 110. According to various embodiments, the concave formation 180 of the main body 112 may facilitate the ventilation of a solar panel supported by the support-flotation-unit 110 as the solar panel is exposed to (or on) the water surface. This ventilation may reduce the temperature of the solar panel or cool the solar panel.

FIG. 4A to FIG. 4D show a perspective view, a side view, a top view and a bottom view of the connecting-floatation-unit 130 of the floating arrangement 100 of FIG. 1 and the floating arrangement 200 of FIG. 2 according to various embodiments.

As shown in FIG. 4A and FIG. 4C, the main body (or elongate main body) 132 of the connecting-floatation-unit 130 is of an elongate shape and has four connection portions (or corner-connection-portions) 136a, 136b, 136c, 136d protruding from four chamfered corner walls 141 of the main body (or elongate main body) 132 of the at least one connecting-floatation-unit 130. According to various embodiments, the elongate shape may be a cuboid-like shape with four chamfered corner walls 141. The main body (or elongate main body) 132 of the connecting-floatation-unit 130 may include the two opposite longitudinal side walls 140a and the two opposite lateral side walls 104b. According to various embodiments, each of the longitudinal side walls 140a may be longer in length than each of the lateral side walls 104b to form the elongate shape. As shown in FIG. 4A and FIG. 4C, each chamfered corner wall 141 is between one longitudinal side wall 140a and one lateral side wall 104b. According to various embodiments, each connection portion (or corner-connection-portion) 136a, 136b, 136c, 136d may be at a respective chamfered corner wall 141 of the main body (or elongate main body) 132. According to various embodiments, each connection portion (or corner-connection-portion) 136a, 136b, 136c, 136d may be protruding sideways from the respective chamfered corner walls 141 of the main body (or elongate main body) 132. According to various embodiments, the four connection portions (or corner-connection-portions) 136a, 136b, 136c, 136d may be at different levels or heights with respect to the flat base (or elongate flat base) 134 of the connecting-floatation-unit 130. For example, two adjacent connection portions (or corner-connection-portions) 136a, 136c along one (or a first) of the two opposite longitudinal side walls 140a may be at a different level or height with respect to the flat base (or elongate flat base) 134 than a level or height of another two adjacent connection portions (or corner-connection-portions) 136b, 136d along another (or a second) of the two opposite longitudinal side walls 140a.

Referring to FIG. 2, as shown, two connection portions (or corner-connection-portions) 116a, 116b of two adjacent legs 122a, 122b of the support-floatation-unit 110 are connected to two connection portions (or corner-connection-portions) 136a, 136c of two adjacent chamfered corner walls 141 of one connecting-floatation-unit 130 along a longitudinal side 145a, i.e. along longitudinal side wall 140a of the pair of adjacent longitudinal and lateral side walls 140a, 140b, of the connecting-floatation-unit 130. Accordingly, the two adjacent legs 122a, 122b of the support-floatation-unit 110, which are directed in the same first direction, are coupled to the same longitudinal side wall 140a of the connecting-floatation-unit 130 with both ends (or side walls 120a) of the two adjacent legs 122a, 122b, which are flushed and levelled, abutting the same longitudinal side wall 140a of the connecting-floatation-unit 130 to form the side-by-side arrangement. As shown, two further connection portions (or corner-connection-portions) 116c, 116d of two further adjacent legs 122c, 122d of the support-floatation-unit 110 are connected to two further connection portions (or corner-connection-portions) 136b, 136d of two adjacent chamfered corner walls 141 of one other connecting-floatation-unit 130 along the longitudinal side wall 140a of the one other connecting-floatation-unit 130. Accordingly, the two further adjacent legs 122c, 122d of the support-floatation-unit 110, which are directed in the same second direction, are coupled to the same longitudinal side wall 140a of the one other connecting-floatation-unit 130 with both ends (or side walls 120a) of the two further adjacent legs 122c, 122d, which are flushed and levelled, abutting the same longitudinal side wall 140a of the one other connecting-floatation-unit 130 to form the side-by-side arrangement.

Referring to FIGS. 4A, 4C and 4D, the main body (or elongate main body) 132 of the connecting-floatation-unit 130 may include at least two straight channel formations 138, each straight channel formation 138 being included (or formed) in respective longitudinal side walls 140a of the main body (or elongate main body) 132 of the at least one connecting-floatation-unit 130. In other words, the main body (or elongate main body) 132 of the at least one connecting-floatation-unit 130 may include at least one straight channel formation 138 in each longitudinal side wall 140a of the two opposite longitudinal side walls 140a of the main body (or elongate main body) 132 of the at least one connecting-floatation-unit 130. Accordingly, the main body (or elongate main body) 132 of the connecting-floatation-unit 130 may include at least a first straight channel formation 138 (or one or more first straight channel formations 138) formed in a first longitudinal side wall 140a (e.g. one of the two opposite longitudinal side walls 140a) of the main body (or elongate main body) 132 of the connecting-floatation-unit 130, and may further include at least a second straight channel formation 138 (or one or more second straight channel formations 138) formed in a second longitudinal side wall 140a (e.g. another of the two opposite longitudinal side walls 140a) of the main body (or elongate main body) 132 of the connecting-floatation-unit 130. According to various embodiments, when the main body (or elongate main body) 132 of the connecting-floatation-unit 130 includes a plurality of straight channel formations 138 in one longitudinal side wall 140a of the main body (or elongate main body) 132 of the connecting-floatation-unit 130, the plurality of straight channel formations 138 may be equally distributed and spaced from each other in the one longitudinal side wall 140a of the main body (or elongate main body) 132 of the connecting-floatation-unit 130. According to various embodiments, a same (or equal) number of straight channel formations 138 may be included (or formed) in each longitudinal side wall 140a of the main body (or elongate main body) 132 of the connecting-floatation-unit 130. For example, each longitudinal side wall 140a may include one or a plurality (i.e. the same or equal number) of straight channel formations 138 included in the longitudinal side wall 140a. According to various embodiments, each straight channel formation 138 included (or formed) in one of the two opposite longitudinal side walls 140a of the main body (or elongate main body) 132 of the connecting-flotation-unit 130 may be directly opposite another straight channel formation 138 included (or formed) in another of the two opposite longitudinal side walls 140a. That is, the at least one straight channel formation 138 included (or formed) in one of the two opposite longitudinal side walls 140a and the at least one straight channel formation 138 included (or formed) in another of the two opposite longitudinal side walls 140a may be positioned a same distance away from one (e.g. a first or a second) lateral side wall 104b of the main body (or elongate main body) 132 of the connecting-flotation-unit 130. According to various embodiments, the two opposite longitudinal side walls 140a (having the at least one straight channel formation 138, or at least one cove formation 168 as described later with reference to FIG. 4E to FIG. 4L) may be identical to each other.

According to various embodiments, each straight channel formation 138 may define one continuous groove extending along an entire length of the straight channel formation 138 without interruption. In other words, between a starting point (or start) and an ending point (or termination) of each straight channel formation 138, the straight channel formation 138 may be devoid of any interruptions or protrusions or partitions or separators or abutting member or extending member etc. Accordingly, each straight channel formation 138 may extend from respective starting point to respective ending point of the straight channel formation 138 to form a continuous or unseparated or undivided or unpartitioned or unobstructed trough (or trench, canal etc.) and having an even (i.e. uninterrupted) surface (e.g. floor, base, bed etc.) along the trough. The surface may be a curved or v-shaped etc. surface, and may be a surface that is entirely exposed (e.g. exposed to the natural element(s), such as any one or more of atmosphere/air, liquid/sea etc.).

Referring to FIGS. 4C and 4D, the at least two straight channel formations 138 on two longitudinal side walls 140a of the main body (or elongate main body) 132 of the connecting-floatation-unit 130 may be part of a continuous endless channel formation which loop around the main body (or elongate main body) 132 of the connecting-floatation-unit 130. Accordingly, the at least two straight channel formations 138 on the two longitudinal side walls 140a of the main body (or elongate main body) 132 may be joined across a top (or across the elongate roof 135) of the main body (or elongate main body) 132 via a first horizontal running channel formation 139a, and the at least two straight channel formations 138 on two longitudinal side walls 140a of the main body (or elongate main body) 132 may be joined across a bottom (or across the flat base 134) of the main body (or elongate main body) 132 via a second horizontal running channel formation 139b. According to various embodiments, the first and second horizontal running channel formations 139a, 139b may run in a path forming an arrow-head shape on respective top and bottom of the main body (or elongate main body) 132. According to various embodiments, the arrow-head shape of the first horizontal running channel formation 139a (across the elongate roof 135) may point in a different direction (e.g. opposite direction, or substantially 180 degrees away about an axial axis of the main body 132) from the direction that the arrow-head shape of the second horizontal running channel formation 139b (across the flat base 134) points towards. For example, the arrow-head shape of the first horizontal running channel formation 139a may point towards a first longitudinal end 131 of the main body (or elongate main body) 132 (e.g. the end of the main body 132 where one of the two opposite lateral side walls 104b is positioned), and the second horizontal running channel formation 139b may point towards a second longitudinal end 133 of the main body (or elongate main body) 132 (e.g. the end of the main body 132 where another of the two opposite lateral side walls 104b is positioned).

Referring to FIG. 3A, FIG. 3B and FIG. 3C, the main body 112 of the support-floatation unit 110 includes at least four straight channel formations 118. Each straight channel formation 118 is being formed in respective one of the two side walls 120a, 120b at respective end portion of respective leg 122a, 122b, 122c, 122d of the main body 112 of the support-floatation unit 110. As shown, according to various embodiments, each straight channel formation 118 may be formed in the outward facing side wall 120b at respective end portion of respective leg 122a, 122b, 122c, 122d of the main body 112 of the support-floatation unit 110. Accordingly, the straight channel formations 118 of the two adjacent legs 122a, 122b of the support-floatation-unit 110, which are directed in the same first direction, may be formed in two opposite outward facing side wall 120b at respective end portion of the two adjacent legs 122a, 122b of the support-floatation-unit 110. The straight channel formations 118 of the two further adjacent legs 122c, 122d of the support-floatation-unit 110, which are directed in the same second direction, may be formed in two opposite outward facing side wall portion 120 at respective end portion of the two further adjacent legs 122c, 122d of the support-floatation-unit 110. According to various embodiments, each straight channel formation 118 may also or may alternatively be formed in the side wall 120a at respective end portion of respective leg 122a, 122b, 122c, 122d which is directed towards the connecting-floatation-unit 130.

Referring to FIG. 4A to FIG. 4D, the main body (or elongate main body) 132 of the connecting-floatation-unit 130 may include an overhanging protrusion (or longitudinally-directed-overhanging-protrusion) 142 extending longitudinally outwards or directed away from an upper half 131a of the first longitudinal end 131 (e.g. the end of the main body 132 where one of the two opposite lateral side walls 104b is positioned) of the main body (or elongate main body) 132 of the connecting-floatation-unit 130 and an underside socket (or longitudinally-aligned-underside-socket) 144 extending inwards at a lower half 131b of the first longitudinal end 131 of the main body (or elongate main body) 132 of the connecting-floatation-unit 130. Accordingly, either or both of the overhanging protrusion (or longitudinally-directed-overhanging-protrusion) 142 and the underside socket (or longitudinally-aligned-underside-socket) 144 may respectively extend in a generally longitudinal direction, and may be parallel or at an angle with respect to a longitudinal axis of the main body (or elongate main body) 132. Further, the main body (or elongate main body) 132 of the connecting-floatation-unit 130 may include an upper-side socket (or longitudinally-aligned-upper-side-socket) 146 extending inwards at an upper half 133a of a second longitudinal end 133 (e.g. the end of the main body 132 where another of the two opposite lateral side walls 104b is positioned) of the main body (or elongate main body) 132 of the connecting-floatation-unit 130 and a foot protrusion (or longitudinally-directed-foot-protrusion) 148 extending longitudinally from a lower half 133b of the second longitudinal end 133 of the main body (or elongate main body) 132 of the connecting-floatation-unit 130. Accordingly, either or both of the upper-side socket (or longitudinally-aligned-upper-side-socket) 146 and the foot protrusion (or longitudinally-directed-foot-protrusion) 148 may respectively extend in a generally longitudinal direction, and may be parallel or at an angle with respect to the longitudinal axis of the main body (or elongate main body) 132. The underside socket (or longitudinally-aligned-underside-socket) 144 at the first longitudinal end 131 is shaped to correspond with a shape of the foot protrusion (or longitudinally-directed-foot-protrusion) 148 at the second longitudinal end 133, and the upper-side socket (or longitudinally-aligned-upper-side-socket) 146 at the second longitudinal end 133 is shaped to correspond with a shape of the overhanging protrusion (or longitudinally-directed-overhanging-protrusion) 142 at the first longitudinal end 131. According to various embodiments, each of the longitudinally-directed-overhanging-protrusion 142 and the longitudinally-directed-foot-protrusion 148 may have a semi-circular-shaped tip (or rounded tip). According to various embodiments, each semi-circular-shaped tip of the longitudinally-directed-overhanging-protrusion 142 and the longitudinally-directed-foot-protrusion 148 may have a curved portion (or curved edge) directed away from the main body (or elongate main body) 132. According to various embodiments, each of the longitudinally-aligned-underside-socket 144 and the longitudinally-aligned-upper-side-socket 146 may be shaped to correspond exactly to that of the longitudinally-directed-overhanging-protrusion 142 and the longitudinally-directed-foot-protrusion 148.

According to various embodiments, two connecting-floatation-units 130 may be joined end to end in a manner whereby the overhanging protrusion (or longitudinally-directed-overhanging-protrusion) 142 at the first longitudinal end 131 of a first of the two connecting-floatation-units 130 may be fitted into the upper-side socket (or longitudinally-aligned-upper-side-socket) 146 at the second longitudinal end 133 of a second of the two connecting-floating-units 130, or the foot protrusion (or longitudinally-directed-foot-protrusion) 148 at the second longitudinal end 133 of the second of the two connecting-floating-units 130 may be fitted into the underside socket (or longitudinally-aligned-underside-socket) 144 at the first longitudinal end 131 of the first of the two connecting-floatation-units 130. Accordingly, the first longitudinal end 131 and the second longitudinal end 133 of each of the two connecting-floatation-units 130 may be configured to be jigsaw-like such that the two connecting-floatation-units 130 may be joined end to end in a manner resembling the joining of two jigsaw pieces together.

Referring to FIGS. 4A, 4C and 4D, at the first longitudinal end 131 of the main body (or elongate main body) 132 of the connecting-floatation-unit 130, a downward facing surface 142a of the overhanging protrusion (or longitudinally-directed-overhanging-protrusion) 142 may transit upwards (e.g. with respect to the flat base 134) to a downward facing surface 144a of the underside socket (or longitudinally-aligned-underside-socket) 144 so as to define a step profile 143 along the transition thereof. Further, at the second longitudinal end 133 of the main body (or elongate main body) 132 of the connecting-floatation-unit 130, an upward facing surface 148a of the foot protrusion (or longitudinally-directed-foot-protrusion) 148 may transit downwards to an upward facing surface 146a of the upper-side socket (or longitudinally-aligned-upper-side-socket) 146 so as to define a step profile 147 along the transition thereof. According to various embodiments, the step profile 143 between the overhanging protrusion (or longitudinally-directed-overhanging-protrusion) 142 and the underside socket (or longitudinally-aligned-underside-socket) 144 at the first longitudinal end 131 of the main body (or elongate main body) 132 of the connecting-floatation-unit 130 may form a first interlocking portion of the connecting-floatation-unit 130, and the step profile 147 between the foot protrusion (or longitudinally-directed-foot-protrusion) 148 and the upper-side socket (or longitudinally-aligned-upper-side-socket) 146 at the second longitudinal end 133 of the main body (or elongate main body) 132 of the connecting-floatation-unit 130 may form a second interlocking portion of the connecting-floatation-unit 130. Accordingly, when the first longitudinal end 131 of a first connecting-floatation-unit 130 is joined to the second longitudinal end 133 of a second connecting-floatation-unit 130, the first interlocking portion (or the step profile 143 between the overhanging protrusion 142 and the underside socket 144) of the first connecting-floatation-unit 130 may interlock or engage with the second interlocking portion (or the step profile 147 between the foot protrusion 148 and the upper-side socket 146) of the second connecting-floatation-unit 130.

According to various embodiments, the first and second interlocking portions of the connecting-floatation-unit 130 may allow two or more connecting-floatation-units 130 to be pre-aligned and held in position before the respective connection portions (or corner-connection-portions) 136 may be joined together to form the connection joint 150. According to various embodiments, the first and second interlocking portions of the connecting-floatation-unit 130 may share a portion of a lateral tension load between the two connecting-floatation-units 130 (i.e. a force pulling apart the two connecting-floatation-units 130) such that the lateral tension load may not be fully bore by the connection joints 150 formed by connecting the connection portions (or corner-connection-portions) 136 of the two connecting-floatation-units 130. Hence, the first and second interlocking portion may serve to ease or minimize the loading at the connection joints. According to various embodiments, the first and second interlocking portions of the connecting-floatation-unit 130 may distribute a vertical load (e.g. from a person walking on the connecting-floatation-unit 130) to the two or more connecting-floatation-units 130 joined together via the first and second interlocking portions.

Referring to FIGS. 4A, 4C and 4D, the main body (or elongate main body) 132 of the connecting-floatation-unit 130 includes one or more hollow tube formations 170 extending perpendicularly from the elongate roof 135 of the main body (or elongate main body) 132 to the flat base (or elongate flat base) 134 of the main body (or elongate main body) 132 in a manner so as to form a through-hole 171 from the elongate roof 135 of the main body (or elongate main body) 132 to the flat base (or elongate flat base) 134 of the main body (or elongate main body) 132. According to various embodiments, the hollow tube formation 170 may be a hollow vertical column extending between the elongate roof 135 of the main body (or elongate main body) 132 and the flat base (or elongate flat base) 134 of the main body (or elongate main body) 132, whereby the elongate roof 135 of the main body (or elongate main body) 132 has an opening for access into the inner cavity of the hollow vertical column and the flat base (or elongate flat base) 134 of the main body (or elongate main body) 132 also has an opening for access into the inner cavity of the hollow vertical column. According to various embodiments, the hollow tube formation 170 may provide additional vertical support for the main body (or elongate main body) 132 of the connecting-floatation-unit 130 such that the connecting-floatation-unit 130 may withstand higher compression load between the elongate roof 135 of the main body (or elongate main body) 132 and the flat base (or elongate flat base) 134 of the main body (or elongate main body) 132. Accordingly, the connecting-floatation-unit 130 may be strengthened to serve as pathway or walkway for user to walk on. Further, the hollow tube formation 170 may also serve as a mooring point for securing the connecting-floatation-unit 130 and/or the floating arrangement 100 to a mooring. Furthermore, the hollow tube formation 170 may also serve as a securing point for user to secure equipment to the connecting-floatation-unit 130 via tying a rope through the hollow tube formation 170. As shown, the connecting-floatation-unit 130 includes two hollow tube formation 170 distributed along a longitudinal axis of the connecting-floatation-unit 130. According to various embodiments, the connecting-floatation-unit 130 may include one or more hollow tube formations 170 distributed along the longitudinal axis of the connecting-floatation-unit 130. According to various embodiments, where the connecting-floatation-unit 130 includes more than one hollow tube formations 170, each hollow tube formation 170 may have a same circular cross-sectional shape of a same diameter as the other hollow tube formations 170. That is, all hollow tube formations 170 of the more than one hollow tube formations 170 may have the same circular cross-sectional shape of the same diameter. According to various embodiments, each hollow tube formation 170 may be positioned along the longitudinal axis of the main body (or elongate main body) 132 such that each hollow tube formation 170 is of a same distance away from either or both of the first longitudinal side wall 140a and the second longitudinal side wall 140a (i.e. of the two opposite longitudinal side walls 140a). According to various embodiments, each hollow tube formation 170 may be positioned directly between the overhanging protrusion (or longitudinally-directed-overhanging-protrusion) 142 and the foot protrusion (or longitudinally-directed-foot-protrusion) 148 of the main body (or elongate main body) 132.

FIG. 4E and FIG. 4F show a perspective top view and a perspective bottom view of a first variant connecting-flotation-unit 130a of the connecting-flotation-unit 130 of the floating arrangement 100 of FIG. 1 and the floating arrangement 200 of FIG. 2 according to various embodiments; FIG. 4G and FIG. 4H show a perspective top view and a perspective bottom view of a second variant connecting-flotation-unit 130b of the connecting-flotation-unit 130 of the floating arrangement 100 of FIG. 1 and the floating arrangement 200 of FIG. 2 according to various embodiments; FIG. 4I and FIG. 4J show a perspective top view and a perspective bottom view of a third variant connecting-flotation-unit 130c of the connecting-flotation-unit 130 of the floating arrangement 100 of FIG. 1 and the floating arrangement 200 of FIG. 2 according to various embodiments; and FIG. 4K and FIG. 4L show a perspective top view and a perspective bottom view of a fourth variant connecting-flotation-unit 130d of the connecting-flotation-unit 130 of the floating arrangement 100 of FIG. 1 and the floating arrangement 200 of FIG. 2 according to various embodiments.

According to various embodiments, each of the first variant connecting-flotation-unit 130a, the second variant connecting-flotation-unit 130b, the third variant connecting-flotation-unit 130c and the fourth variant connecting-flotation-unit 130d, may, similar to the connecting-flotation-unit 130, include a main body (or elongate main body) 132 having a flat base (or elongate flat base) 134, an elongate roof 135 opposite the flat base (or elongate flat base) 134, and two opposite longitudinal side walls 140a and two opposite lateral side walls 140b, and further include at least one connection portion (or corner-connection-portion) 136 protruding sideways from a chamfered corner wall 141 between two side walls 140a, 140b (or a pair of adjacent longitudinal and lateral side walls 140a, 140b) of the main body (or elongate main body) 132. According to various embodiments, the at least one connection portion (or corner-connection-portion) 136 is protruding in a direction along a plane parallel with the flat base (or elongate flat base) 134. As shown in FIG. 4E to 4L, the main body (or elongate main body) 132 of each of the first variant connecting-flotation-unit 130a, the second variant connecting-flotation-unit 130b, the third variant connecting-flotation-unit 130c and the fourth variant connecting-flotation-unit 130d includes four connection portions (or corner-connection-portions) 136a, 136b, 136c, 136d. According to various embodiments, the main body (or elongate main body) 132 of each of the first variant connecting-flotation-unit 130a, the second variant connecting-flotation-unit 130b, the third variant connecting-flotation-unit 130c and the fourth variant connecting-flotation-unit 130d may, similar to the main body (or elongate main body) 132 of the connecting-flotation-unit 130, further include at least one straight channel formation 138 extending vertically (or perpendicularly) upwards with respect to respective flat base 134. According to various embodiments, the main body (or elongate main body) 132 of each of the first variant connecting-flotation-unit 130a, the second variant connecting-flotation-unit 130b, the third variant connecting-flotation-unit 130c and the fourth variant connecting-flotation-unit 130d may further include at least one cove formation 168 extending vertically (or perpendicularly) upwards with respect to the flat base (or elongate flat base) 134. According to various embodiments, the at least one cove formation 168 may be a depression or a concave portion or an indentation along (e.g. at position(s) along; or on) one or each of the two longitudinal side walls 140a of the respective main body (or elongate main body) 132. As shown in FIG. 4E to FIG. 4L, the main body (or elongate main body) 132 of each of the first variant connecting-flotation-unit 130a, the second variant connecting-flotation-unit 130b, the third variant connecting-flotation-unit 130c and the fourth variant connecting-flotation-unit 130d includes at least two cove formations 168, each cove formation 168 being included (or formed) in respective longitudinal side walls 140a.

According to various embodiments, the at least one cove formation 168 may be a V-shaped depression or indentation. According to various embodiments, each cove formation 168 may, similar to the straight channel formation 138 of the connecting-flotation-unit 130, extend or run along an entire height (or thickness) of the respective main body (or elongate main body) 132 of the at least one connecting-floatation-unit 130a, 130b, 130c, 130d. According to various embodiments, each cove formation 168 may be wider and/or deeper than the straight channel formation 138 of the connecting-flotation-unit 130 so as to accommodate at least one laterally-directed-connection-portion 166. According to various embodiments, each cove formation 168 may be sized to receive or include at least one laterally-directed-connection-portion 166 protruding sideways from the longitudinal side wall 140a and positioned within each cove formation 168. Accordingly, according to various embodiments, the main body (or elongate main body) 132 of each of the first variant connecting-flotation-unit 130a, the second variant connecting-flotation-unit 130b, the third variant connecting-flotation-unit 130c and the fourth variant connecting-flotation-unit 130d may include at least one laterally-directed-connection-portion 166 protruding sideways from the longitudinal side wall 140a and positioned within each cove formation 168. As shown in FIG. 4E to FIG. 4L, the main body (or elongate main body) 132 may include four laterally-directed-connection-portions 166a, 166b, 166c, 166d. According to various embodiments, each laterally-directed-connection-portion 166a, 166b, 166c, 166d may be positioned within a respective cove formation 168. According to various embodiments, each laterally-directed-connection-portion 166 may, similar to the connection portion (or corner-connection-portion) 136 of the connecting-flotation-unit 130, include a connection lug 15 with an eyehole 16. Accordingly, according to various embodiments, respective laterally-directed-connection-portion 166 of respective connecting-flotation-unit 130a, 130b, 130c, 130d may be coupled to each other (e.g. via a nut and bolt assembly) to form respective connection joints.

According to various embodiments, the main body (or elongate main body) 132 of each of the first variant connecting-flotation-unit 130a, the second variant connecting-flotation-unit 130b, the third variant connecting-flotation-unit 130c and the fourth variant connecting-flotation-unit 130d may, similar to the main body (or elongate main body) 132 of the connecting-flotation-unit 130, further include a first interlocking portion formed by an overhanging protrusion (or longitudinally-directed-overhanging-protrusion) 142 extending longitudinally outwards from an upper half 131a of a first longitudinal end 131 and an underside socket (or longitudinally-aligned-underside-socket) 144 extending inwards at a lower half 131b of the first longitudinal end 131. Further, according to various embodiments, the main body (or elongate main body) 132 of each of the first variant connecting-flotation-unit 130a, the second variant connecting-flotation-unit 130b, the third variant connecting-flotation-unit 130c and the fourth variant connecting-flotation-unit 130d may, similar to the main body (or elongate main body) 132 of the connecting-flotation-unit 130, include a second interlocking portion formed by an upper-side socket (or longitudinally-aligned-upper-side-socket) 146 extending inwards at an upper half 133a of a second longitudinal end 133 and a foot protrusion (or longitudinally-directed-foot-protrusion) 148 extending longitudinally from a lower half 133b of the second longitudinal end 133.

According to various embodiments, the second variant connecting-flotation-unit 130b and the third variant connecting-flotation-unit 130c may differ from the first variant connecting-flotation-unit 130a in that each of the second variant connecting-flotation-unit 130b and the third variant connecting-flotation-unit 130c includes a third interlocking portion along a longitudinal side wall 140a.

As shown, in FIG. 4G and FIG. 4H, according to various embodiments, the main body (or elongate main body) 132 of the second variant connecting-flotation-unit 130b may further include a laterally-directed-overhanging-protrusion 182 extending laterally outwards from an upper half 161a of a first longitudinal side wall 140a (e.g. one of the two opposite longitudinal side walls 140a) of the main body (or elongate main body) 132, and a laterally-aligned-underside-socket 184 extending inwards at a lower half 161b of the first longitudinal side wall 140a of the main body (or elongate main body) 132. According to various embodiments, either or both of the laterally-directed-overhanging-protrusion 182 and the laterally-aligned-underside-socket 184 may respectively extend in a generally lateral direction or transverse direction, and may be parallel or at an angle with respect to a lateral axis or transverse axis of the main body (or elongate main body) 132. The lateral direction or transverse direction may be a direction across a width of the main body (or elongate main body) 132. Accordingly, the lateral axis or transverse axis may lie in a lateral plane of the main body (or elongate main body) 132 and may be perpendicular or substantially perpendicular to the longitudinal axis of the main body (or elongate main body) 132. According to various embodiments, at the first longitudinal side wall 140a of the main body (or elongate main body) 132 of the second variant connecting-flotation-unit 130b, a downward facing surface 182a of the laterally-directed-overhanging-protrusion 182 may transit upwards to a downward facing surface 184a of the laterally-aligned-underside-socket 184 so as to define a step profile 183 along said transition. The laterally-directed-overhanging-protrusion 182 and the laterally-aligned-underside-socket 184 may form the third interlocking portion of the second variant connecting-flotation-unit 130b. According to various embodiments, the laterally-directed-overhanging-protrusion 182 may have a semi-circular-shaped tip (or rounded tip). According to various embodiments, the semi-circular-shaped tip of the laterally-directed-overhanging-protrusion 182 may have a curved portion (or curved edge) directed away from the main body (or elongate main body) 132. According to various embodiments, laterally-aligned-underside-socket 184 may be shaped to correspond exactly to that of the laterally-directed-overhanging-protrusion 182.

Referring to FIG. 4I and FIG. 4J, according to various embodiments, the main body (or elongate main body) 132 of the third variant connecting-flotation-unit 130b may further include a laterally-aligned-upper-side-socket 186 extending inwards at an upper half 163a of a second longitudinal side wall 140a (e.g. another side wall opposite the first longitudinal side wall) of the main body (or elongate main body) 132 and a laterally-directed-foot-protrusion 188 extending laterally from a lower half 163b of the second longitudinal side wall 140a of the main body (or elongate main body) 132. According to various embodiments, either or both of the laterally-aligned-upper-side-socket 186 and the laterally-directed-foot-protrusion 188 may respectively extend in a generally lateral direction or traverse direction, and may be parallel or at an angle with respect to the lateral axis or traverse axis of the main body (or elongate main body) 132. According to various embodiments, at the second longitudinal side wall 140a of the main body (or elongate main body) 132 of the third variant connecting-flotation-unit 130c, an upward facing surface 188a of the laterally-directed-foot-protrusion 188 may transit downwards to an upward facing surface 186a of the laterally-aligned-upper-side-socket 186 so as to define a step profile 187 along said transition. The laterally-directed-foot-protrusion 188 and the laterally-aligned-upper-side-socket 186 may form the third interlocking portion of the third variant connecting-flotation-unit 130c. According to various embodiments, the laterally-directed-foot-protrusion 188 may have a semi-circular-shaped tip (or rounded tip). According to various embodiments, the semi-circular-shaped tip of the laterally-directed-foot-protrusion 188 may have a curved portion (or curved edge) directed away from the main body (or elongate main body) 132. According to various embodiments, laterally-aligned-upper-side-socket 186 may be shaped to correspond exactly to that of the laterally-directed-foot-protrusion 188.

According to various embodiments, when the first longitudinal side wall 140a of the second variant connecting-flotation-unit 130b is joined to the second longitudinal side wall 140a of the third variant connecting-flotation-unit 130c, the third interlocking portion (or the step profile 183 between the laterally-directed-overhanging-protrusion 182 and the laterally-aligned-underside-socket 184) of the second variant connecting-flotation-unit 130b may interlock or engage with the third interlocking portion (or the step profile 187 between the laterally-directed-foot-protrusion 188 and the laterally-aligned-upper-side-socket 186) of the third variant connecting-flotation-unit 130c.

According to various embodiments, the laterally-aligned-underside-socket 184 may be shaped to correspond with a shape of the laterally-directed-foot-protrusion 188, and the laterally-aligned-upper-side-socket 186 may be shaped to correspond with a shape of the laterally-directed-overhanging-protrusion 182.

As shown in FIG. 4K and FIG. 4L, according to various embodiments, the fourth variant connecting-flotation-unit 130d may include a third interlocking portion and a fourth interlocking portion. The third interlocking portion may include the laterally-directed-overhanging-protrusion 182 and the laterally-aligned-underside-socket 184 at the first longitudinal side wall 140a of the main body (or elongate main body) 132, and the fourth interlocking portion may include the laterally-directed-foot-protrusion 188 and the laterally-aligned-upper-side-socket 186 at the second longitudinal side wall 140a of the main body (or elongate main body) 132. The third interlocking portion of the fourth variant connecting-flotation-unit 130d may be similar to the third interlocking portion of the second variant connecting-flotation-unit 130b and include a step profile 183 along the transition between the laterally-directed-overhanging-protrusion 182 and the laterally-aligned-underside-socket 184. The fourth interlocking portion of the fourth variant connecting-flotation-unit 130d may be similar to the third interlocking portion of the third variant connecting-flotation-unit 130c include a step profile 187 along the transition between the laterally-directed-foot-protrusion 188 and the laterally-aligned-upper-side-socket 186.

According to various embodiments, the third and/or fourth interlocking portions of the respective connecting-floatation-unit 130b, 130c, 130d of FIG. 4E to FIG. 4L may allow two or more connecting-floatation-units 130b, 130c, 130d to be pre-aligned and held in a side-by-side manner or alongside each other before the respective connection portion (or corner-connection-portion) 136 and respective laterally-directed-connection-portion 166 may be joined together to form the respective connection joint. According to various embodiments, the third and/or fourth interlocking portions of the respective connecting-floatation-unit 130b, 130c, 130d may share a portion of a lateral tension load between the two connecting-floatation-units 130b, 130c or 130d (i.e. a force pulling apart the two connecting-floatation-units 130b, 130c or 130d) such that the lateral tension load may not be fully bore by the respective connection joint. According to various embodiments, the third and fourth interlocking portions of the connecting-floatation-unit 130 may distribute a vertical load (e.g. from a person walking on the connecting-floatation-unit 130) to the two or more connecting-floatation-units 130 joined together via the third and fourth interlocking portions.

Referring to FIGS. 3A and 3C, the support-floatation-unit 110 includes four mounting portions 124a, 124b, 124c, 124d. Each mounting portion 124a, 124b, 124c, 124d may be at the end portion of the respective leg 122a, 122b, 122c, 122d of the support-floatation-unit 110. According to various embodiments, each mounting portion 124a, 124b, 124c, 124d may be a flat panel structure at the end portion of the respective leg 122a, 122b, 122c. 122d of the support-floatation-unit 110. Each flat panel structure may include a plurality of holes 126. According to various embodiments, the plurality of holes maybe configured for attaching a solar panel to the support-floatation-unit 110. As shown, the mounting portion 124a, 124b, 124c, 124d of the respective leg 122a, 122b, 122c, 122d may include a rectangular flat panel structure with two rows of four holes. According to various embodiments, each leg of a solar panel may be placed on respective mounting portion 124a, 124b, 124c, 124d. Screws may then be inserted from underneath the respective mounting portion 124a, 124b, 124c, 124d through the plurality of holes 126 for securing to the leg of the solar panel to the respective mounting portion 124a, 124b, 124c, 124d.

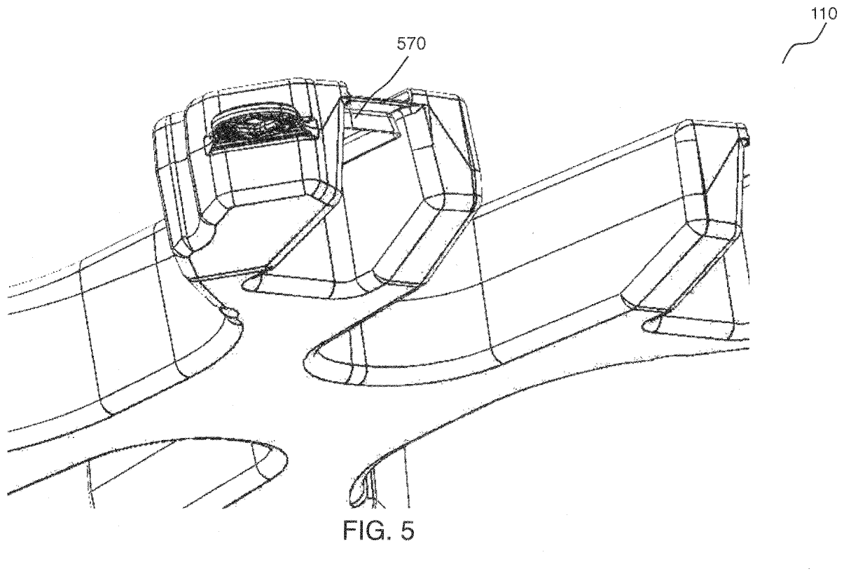

FIG. 5 shows a perspective bottom view of the support-floatation-unit 110 according to various embodiments. As shown, a strengthening attachment 570 may be added to the underneath of the respective mounting portion 124a, 124b, 124c, 124d for enhancing and strengthening the respective mounting portion 124a, 124b, 124c, 124d to hold and retain the solar panel to the support-floatation-unit 110. According to various embodiments, the strengthening attachment 570 may be of various shapes. As shown in FIG. 5, the strengthening attachment 570 may be of an inverted tray-like shape.

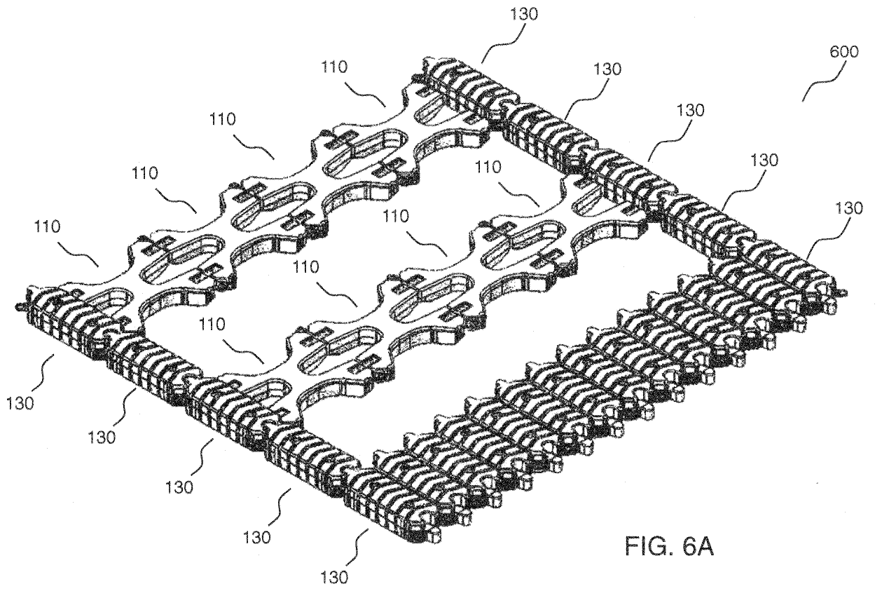

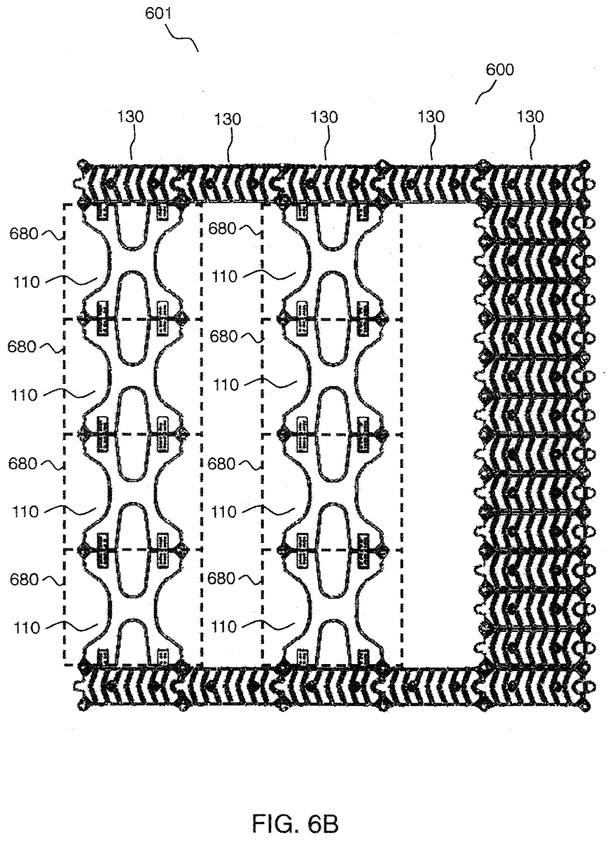

FIG. 6A and FIG. 6B shows a perspective view and a top view of a floating arrangement 600 according to various embodiments. As shown, the floating arrangement 600 may include a plurality of support-floatation-units 110 and a plurality of connecting-floatation-units 130. The plurality of support-floatation-units 110 may be connected to form rows of support-floatation-units 110 such that a plurality of solar panels may be mounted to the plurality of support-floatation-units 110 to form rows of solar panels. Further, the plurality of connecting-floatation-units 130 may be connected to form a border frame structure, whereby the rows of support-floatation-units 110 are framed within the border frame structure.

According to various embodiments, a width of the H-shape support-floatation-unit 110 may be equal to a length of the elongate connecting-floatation-unit 130. According to various embodiments, a length of the H-shape support-floatation-unit may be equal to three times a width of the elongate connecting-floatation-unit 130. Accordingly, when forming the border frame structure to frame the rows of support-floatation-units 110, the plurality of the connecting-floatation-units 130 may be arranged accordingly to fit the rows of support-floatation-units 110.

In FIG. 6B, the plurality of solar panels 680 are illustrated by broken lines. As shown, according to various embodiments, there may be provided a floating solar panels system 601. The floating solar panels system 601 may include the floating arrangement according to the various embodiments and at least one solar panel mounted to at least support-floatation-unit of the floating arrangement.

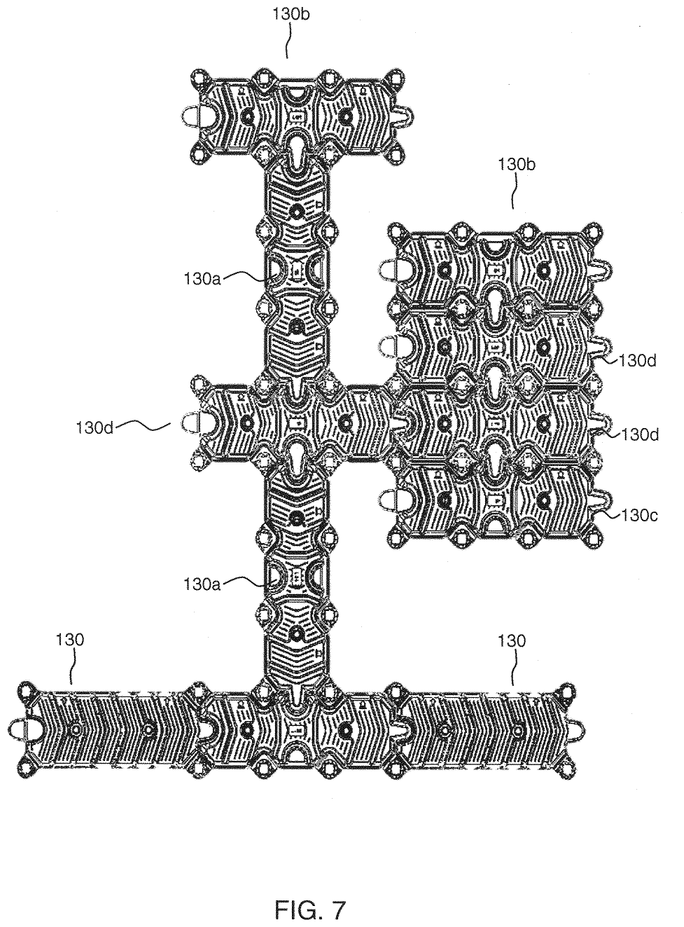

FIG. 7 shows a top view of an example arrangement of the first variant connecting-flotation-unit 130a, second variant connecting-flotation-unit 130b, third variant connecting-flotation-unit 130c and fourth variant connecting-flotation-unit 130d, according to various embodiments. As shown in FIG. 7, the first variant connecting-flotation-unit 130a, second variant connecting-flotation-unit 130b, third variant connecting-flotation-unit 130c and fourth variant connecting-flotation-unit 130d may be connected to each other via respective connection portions, respective overhanging protrusions and/or respective foot protrusions of respective main bodies of the first variant connecting-flotation-unit 130a, second variant connecting-flotation-unit 130b, third variant connecting-flotation-unit 130c and fourth variant connecting-flotation-unit 130d. The respective overhanging protrusions and respective foot protrusions may provide stability and strength to the assembled arrangement of the first variant connecting-flotation-unit 130a, second variant connecting-flotation-unit 130b, third variant connecting-flotation-unit 130c and fourth variant connecting-flotation-unit 130d, and may also absorb (or bear) any force (or load) that act (or is applied) on any or all of the first variant connecting-flotation-unit 130a, second variant connecting-flotation-unit 130b, third variant connecting-flotation-unit 130c and fourth variant connecting-flotation-unit 130d.

Various embodiments have provided a floating arrangement that may be effective and durable in supporting solar panels out in the open seas and ocean. The floating arrangement may be configured to reduce or minimize or eliminate loading at the connection joint between two floatation units and the individual floatation units may be enhanced and strengthen to withstand the harsh environment in the open seas and ocean. Accordingly, the floating arrangement of the various embodiments may be deployed in open seas and ocean for supporting solar panels.

While the invention has been particularly shown and described with reference to specific embodiments, it should be understood by those skilled in the art that various changes, modification, variation in form and detail may be made therein without departing from the scope of the invention as defined by the appended claims. The scope of the invention is thus indicated by the appended claims and all changes which come within the meaning and range of equivalency of the claims are therefore intended to be embraced.

1. A floating arrangement for supporting a solar panel, comprising
at least one support-floatation-unit for supporting a solar panel, the support-floatation-unit comprising a main body having a flat base and at least one connection portion protruding sideways from a chamfered corner wall between two side walls of the main body in a direction parallel with the flat base; and
at least one connecting-floatation-unit comprising a main body having a flat base and at least one connection portion protruding sideways from a chamfered corner wall between two side walls of the main body in a direction parallel with the flat base,
wherein the at least one connection portion of the at least one support-floatation-unit is coupled to the at least one connection portion of the at least one connecting-floatation-unit to form a connection joint which connects the at least one support-floatation-unit and the at least one connecting-floatation-unit in a side-by-side arrangement, whereby one of the two side walls of the main body of the at least one support-floatation-unit abuts one of the two side walls of the main body of the at least one connecting-floatation-unit,
wherein a height from the flat base of the at least one support-floatation-unit to a center of the connection joint is larger than a height from the flat base of the at least one connecting-floatation-unit to the center of the connection joint in a manner such that the flat base of the at least one support-floatation-unit extends downwards from a base level of the flat base of the at least one connecting-floatation-unit by a depth which defines an additional displacement volume of the at least one-support-floatation-unit configured to provide additional buoyancy to support the solar panel,
wherein the main body of the at least one connecting-floatation unit is of an elongate shape,
wherein the main body of the at least one connecting-floatation-unit comprises an overhanging protrusion extending longitudinally outwards from an upper half of a first longitudinal end of the main body of the at least one connecting-floatation-unit and an underside socket extending inwards at a lower half of the first longitudinal end of the main body of the at least one connecting-floatation-unit,
wherein the main body of the at least one connecting-floatation-unit further comprises an upper-side socket extending inwards at an upper half of a second longitudinal end of the main body of the at least one-connecting-floatation-unit and a foot protrusion extending longitudinally from a lower half of the second longitudinal end of the main body of the at least one-connecting-floatation-unit.

2. The arrangement as claimed in claim 1, wherein respective main body of the at least one support-floatation-unit and the at least one connecting-floatation-unit comprises at least one straight channel formation extending vertically upwards with respect to respective flat bases, the at least one straight channel formation being formed by an inward bend in respective one of the two side walls located adjacent to the respective chamfered corner wall having respective connection portion.

3. The arrangement as claimed in claim 2, wherein the at least one straight channel formation extends between the respective flat bases and respective roofs of the respective main body of the at least one support-floatation-unit and the at least one connecting-floatation-unit.

4. The arrangement as claimed in claim 3, wherein the at least one straight channel formation defines one continuous groove extending along an entire length of the straight channel formation without interruption.

5. The arrangement as claimed in claim 1, wherein respective main body of the at least one support-floatation-unit and the at least one connecting-floatation-unit comprises at least one straight ridge formation extending vertically upwards with respect to respective flat bases, the at least one straight ridge formation being formed by an outward bend in respective one of the two side walls located adjacent to the respective chamfered corner wall having respective connection portion.

6. The arrangement as claimed in claim 1,
wherein the main body of the at least one connecting-floatation unit has four connection portions protruding from four chamfered corner walls of the main body of the at least one connecting-floatation unit, each connection portion being at a respective chamfered corner wall,
wherein the main body of the at least one support-floatation-unit is of a H-shape and has four connection portions protruding from four legs of the main body of the at least one support-floatation-unit, each connection portion being at a chamfered corner wall between two side walls of an end portion of a respective leg,
wherein two connection portions of two adjacent legs of the at least one support-floatation-unit are connected to two connection portions of two adjacent chamfered corner walls of the at least one connecting-floatation-unit along a longitudinal side wall of the at the at least one connecting-floatation-unit.

7. The arrangement as claimed in claim 1, wherein the main body of the at least one support-floatation-unit has at least one concave formation recessed into at least one side wall of the main body of the support-floatation-unit.

8. The arrangement as claimed in claim 7, wherein the main body of the at least one support-floatation-unit has at least four concave formation each recessed into at least one side wall of the main body of the support-floatation-unit.

9. The arrangement as claimed in claim 2, wherein the main body of the at least one connecting-floatation-unit comprises at least two straight channel formations, each straight channel formation being formed in respective longitudinal side walls of the main body of the at least one connecting-floatation-unit.

10. The arrangement as claimed in claim 9, wherein a same number of straight channel formations is formed in each longitudinal side wall of the main body of the at least one connecting-floatation-unit.

11. The arrangement as claimed in claim 9, wherein each straight channel formation formed in each longitudinal side wall is directly opposite another straight channel formation formed in an opposite longitudinal side wall.

12. The arrangement as claimed in claim 2, wherein the main body of the at least one support-floatation-unit comprises at least four straight channel formations, each straight channel formation being formed in respective one of the two side walls at respective end portion of respective leg of the main body of the at least one support-floatation-unit.

13. The arrangement as claimed in claim 1,
wherein the underside socket at the first longitudinal end is shaped to correspond with a shape of the foot protrusion at the second longitudinal end, and
wherein the upper-side socket at the second longitudinal end is shaped to correspond with a shape of the overhanging protrusion at the first longitudinal end.

14. The arrangement as claimed in claim 1,
wherein, at the first longitudinal end of the main body of the at least one connecting-floatation-unit, a downward facing surface of the overhanging protrusion transit upwards to a downward facing surface of the underside socket so as to define a step profile along said transition,
wherein, at the second longitudinal end of the main body of the at least one connecting-floatation-unit, an upward facing surface of the foot protrusion transit downwards to an upward facing surface of the upper-side socket so as to define a step profile along said transition.

15. The arrangement as claimed in claim 1,
wherein the main body of the at least one connecting-floatation-unit further comprises a laterally-directed-overhanging-protrusion extending laterally outwards from an upper half of a first longitudinal side wall of the main body of the at least one connecting-floatation-unit and a laterally-aligned-underside-socket extending inwards at a lower half of the first longitudinal side wall of the main body of the at least one connecting-floatation-unit.

16. The arrangement as claimed in claim 15,
wherein, at the first longitudinal side wall of the main body of the at least one connecting-floatation-unit, a downward facing surface of the laterally-directed-overhanging-protrusion transits upwards to a downward facing surface of the laterally-aligned-underside-socket so as to define a step profile along said transition.

17. The arrangement as claimed in claim 1,
wherein the main body of the at least one connecting-floatation-unit further comprises a laterally-aligned-upper-side-socket extending inwards at an upper half of a second longitudinal side wall of the main body of the at least one connecting-floatation-unit and a laterally-directed-foot-protrusion extending laterally from a lower half of the second longitudinal side wall of the main body of the at least one connecting-floatation-unit.

18. The arrangement of claim 17,
wherein, at the second longitudinal side wall of the main body of the at least one connecting-floatation-unit, an upward facing surface of the laterally-directed-foot-protrusion transits downwards to an upward facing surface of the laterally-aligned-upper-side-socket so as to define a step profile along said transition.

19. The arrangement as claimed in claim 17,
wherein a laterally-aligned-underside-socket at the first longitudinal side wall is shaped to correspond with a shape of the laterally-directed-foot-protrusion at the second longitudinal side wall, and
wherein the laterally-aligned-upper-side-socket at the second longitudinal side wall is shaped to correspond with a shape of a laterally-directed-overhanging-protrusion at the first longitudinal side wall.

20. The arrangement as claimed in claim 1, wherein the main body of the at least one connecting-floatation-unit further comprises at least one cove formation recessed into a longitudinal side of the main body of the at least one connecting-floatation-unit.

21. The arrangement as claimed in claim 20, wherein the main body of the at least one connecting-floatation-unit further comprises at least two cove formations, each recessed into respective longitudinal sides of the main body of the at least one connecting-floatation-unit.

22. The arrangement as claimed in claim 20, wherein the main body of the at least one connecting-floatation-unit further comprises at least one laterally-directed-connection-portion protruding away from each cove formation.

23. The arrangement as claimed in claim 1, wherein the main body of the at least one connecting-floatation-unit comprises one or more hollow tube formations extending perpendicularly from a roof of the main body to the flat base of the main body in a manner so as to form a through-hole from the roof of the main body to the flat base of the main body.

24. The arrangement as claimed in claim 1, wherein each main body of the at least one support-floatation-unit and the at least one connecting-floatation-unit comprises a hollow watertight container.

25. The arrangement as claimed in claim 1, wherein each connection portion of the at least one support-floatation-unit and the at least one connecting-floatation-unit comprises a connection lug with respective eyehole axis being perpendicular to respective flat base.

26. The arrangement as claimed in claim 25, wherein the connection lug of the at least one support-floatation-unit and the connection lug of the at least one connecting-floatation-unit are coupled together with a nut and bolt to form the connection joint.

27. A floating solar panel system comprising:
the floating arrangement according to claim 1; and
at least one solar panel mounted to the at least one support-floatation-unit.

28. A connecting-floatation-unit comprising:
a main body having a flat base and at least one connection portion protruding sideways from a chamfered corner wall between two side walls of the main body in a direction parallel with the flat base,
wherein the main body of the connecting-floatation unit is of an elongate shape,
wherein the main body of the connecting-floatation-unit comprises an overhanging protrusion extending longitudinally outwards from an upper half of a first longitudinal end of the main body of the connecting-floatation-unit and an underside socket extending inwards at a lower half of the first longitudinal end of the main body of the connecting-floatation-unit,
wherein the main body of the connecting-floatation-unit further comprises an upper-side socket extending inwards at an upper half of a second longitudinal end of the main body of the at least one-connecting-floatation-unit and a foot protrusion extending longitudinally from a lower half of the second longitudinal end of the main body of the at least one-connecting-floatation-unit.

29. The connecting-floatation-unit of claim 28,
wherein main body of the connecting-floatation-unit comprises at least one straight channel formation extending vertically upwards with respect to the flat base, the at least one straight channel formation being formed by an inward bend in one of the two side walls located adjacent to the chamfered corner wall having the at least one connection portion.

30. The connecting-floatation-unit of claim 29,
wherein the at least one straight channel formation extends between the flat base and a roof of the main body of the connecting-floatation-unit.

31. The connecting-floatation-unit of claim 30,
wherein the at least one straight channel formation defines one continuous groove extending along an entire length of the straight channel formation without interruption.

32. The connecting-floatation-unit of claim 28,
wherein the main body of the connecting-floatation-unit comprises at least one straight ridge formation extending vertically upwards with respect to the flat base, the at least one straight ridge formation being formed by an outward bend in one of the two side walls located adjacent to the chamfered corner wall having the at least one connection portion.

33. The connecting-floatation-unit of claim 28,
wherein the main body of the connecting-floatation unit has four connection portions protruding from four chamfered corner walls of the main body of the connecting-floatation unit, each connection portion being at a respective chamfered corner wall.

34. The connecting-floatation-unit of claim 28,
wherein the main body of the connecting-floatation-unit comprises at least two straight channel formations, each straight channel formation being formed in respective longitudinal side walls of the main body of the connecting-floatation-unit.

35. The connecting-floatation-unit of claim 34,
wherein a same number of straight channel formations is formed in each longitudinal side wall of the main body of the connecting-floatation-unit.

36. The connecting-floatation-unit of claim 34,
wherein each straight channel formation formed in each longitudinal side wall is directly opposite another straight channel formation formed in an opposite longitudinal side wall.

37. The connecting-floatation-unit of claim 28,
wherein the underside socket at the first longitudinal end is shaped to correspond with a shape of the foot protrusion at the second longitudinal end, and
wherein the upper-side socket at the second longitudinal end is shaped to correspond with a shape of the overhanging protrusion at the first longitudinal end.

38. The connecting-floatation-unit of claim 28,
wherein, at the first longitudinal end of the main body of the connecting-floatation-unit, a downward facing surface of the overhanging protrusion transit upwards to a downward facing surface of the underside socket so as to define a step profile along said transition,
wherein, at the second longitudinal end of the main body of the connecting-floatation-unit, an upward facing surface of the foot protrusion transit downwards to an upward facing surface of the upper-side socket so as to define a step profile along said transition.

39. The connecting-floatation-unit of claim 28,
wherein the main body of the connecting-floatation-unit further comprises a laterally-directed-overhanging-protrusion extending laterally outwards from an upper half of a first longitudinal side wall of the main body of the connecting-floatation-unit and a laterally-aligned-underside-socket extending inwards at a lower half of the first longitudinal side wall of the main body of the connecting-floatation-unit.

40. The connecting-floatation-unit of claim 39,
wherein, at the first longitudinal side wall of the main body of the connecting-floatation-unit, a downward facing surface of the laterally-directed-overhanging-protrusion transits upwards to a downward facing surface of the laterally-aligned-underside-socket so as to define a step profile along said transition.

41. The connecting-floatation-unit of claim 28,
wherein the main body of the connecting-floatation-unit further comprises a laterally-aligned-upper-side-socket extending inwards at an upper half of a second longitudinal side wall of the main body of the connecting-floatation-unit and a laterally-directed-foot-protrusion extending laterally from a lower half of the second longitudinal side wall of the main body of the connecting-floatation-unit.

42. The connecting-floatation-unit of claim 41,
wherein, at the second longitudinal side wall of the main body of the connecting-floatation-unit, an upward facing surface of the laterally-directed-foot-protrusion transits downwards to an upward facing surface of the laterally-aligned-upper-side-socket so as to define a step profile along said transition.

43. The connecting-floatation-unit of claim 41,
wherein a laterally-aligned-underside-socket at the first longitudinal side wall is shaped to correspond with a shape of the laterally-directed-foot-protrusion at the second longitudinal side wall, and
wherein the laterally-aligned-upper-side-socket at the second longitudinal side wall is shaped to correspond with a shape of a laterally-directed-overhanging-protrusion at the first longitudinal side wall.

44. The connecting-floatation-unit of claim 28,
wherein the main body of the connecting-floatation-unit further comprises at least one cove formation recessed into a longitudinal side of the main body of the connecting-floatation-unit.

45. The connecting-floatation-unit of claim 44,
wherein the main body of the connecting-floatation-unit further comprises at least two cove formations, each recessed into respective longitudinal sides of the main body of the connecting-floatation-unit.

46. The connecting-floatation-unit of claim 44,
wherein the main body of the connecting-floatation-unit further comprises at least one laterally-directed-connection-portion protruding away from each cove formation.

47. The connecting-floatation-unit of claim 28,
wherein the main body of the connecting-floatation-unit comprises one or more hollow tube formations extending perpendicularly from a roof of the main body to the flat base of the main body in a manner so as to form a through-hole from the roof of the main body to the flat base of the main body.

48. The connecting-floatation-unit of claim 28,
wherein the main body of the connecting-floatation-unit comprises a hollow watertight container.

49. The connecting-floatation-unit of claim 28,
wherein each connection portion of the connecting-floatation-unit comprises a connection lug with respective eyehole axis being perpendicular to the flat base.

50. A support-floatation-unit for supporting a solar panel, comprising
a main body having a flat base and at least one connection portion protruding sideways from a chamfered corner wall between two side walls of the main body in a direction parallel with the flat base,
wherein the main body of the support-floatation-unit is of a H-shape.

51. The support-floatation-unit of claim 50, wherein the main body of the support-floatation-unit has at least one concave formation recessed into at least one side wall of the main body of the support-floatation-unit.

52. The support-floatation-unit of claim 51, wherein the main body of the support-floatation-unit has at least four concave formation each recessed into at least one side wall of the main body of the support-floatation-unit.

53. The support-floatation-unit of claim 50,
wherein respective main body of the support-floatation-unit comprises at least one straight channel formation extending vertically upwards with respect to the flat base, the at least one straight channel formation being formed by an inward bend in one of the two side walls located adjacent to the chamfered corner wall having the at least one connection portion.

54. The support-floatation-unit of claim 53,
wherein the at least one straight channel formation extends between the flat base and a roof of the main body of the support-floatation-unit.

55. The support-floatation-unit of claim 50,
wherein respective main body of the support-floatation-unit comprises at least one straight ridge formation extending vertically upwards with respect to the flat base, the at least one straight ridge formation being formed by an outward bend in one of the two side walls located adjacent to the chamfered corner wall having the at least one connection portion.

56. The support-floatation-unit of claim 50,
wherein the main body of the support-floatation-unit has four connection portions protruding from four legs of the main body of the support-floatation-unit, each connection portion being at a chamfered corner wall between two side walls of an end portion of a respective leg.

57. The support-floatation-unit of claim 50,
wherein the main body of the support-floatation-unit comprises at least four straight channel formations, each straight channel formation being formed in respective one of the two side walls at respective end portion of respective leg of the main body of the support-floatation-unit.

58. The support-floatation-unit of claim 50, wherein the main body of the support-floatation-unit comprises a hollow watertight container.

59. The support-floatation-unit of claim 50, wherein each connection portion of the support-floatation-unit comprises a connection lug with respective eyehole axis being perpendicular to the flat base.
